(19) United States
(12) Patent Application Publication
(10) Pub. No.: US 2024/0068351 A1
(43) Pub. Date: Feb. 29, 2024

(54) COMPOSITE WELL CURVE GENERATION WITH MACHINE LEARNING

(71) Applicant: Nabors Drilling Technologies USA, Inc., Houston, TX (US)

(72) Inventors: Malini Manocha, Cypress, TX (US); Ryan Bott, Houston, TX (US); Vineet Sawant, Tomball, TX (US)

(21) Appl. No.: 18/450,480

(22) Filed: Aug. 16, 2023

Related U.S. Application Data
(60) Provisional application No. 63/373,249, filed on Aug. 23, 2022.

(51) Int. Cl. E21B 44/00; G01V 1/50

(52) U.S. Cl. CPC E21B 44/005; G01V 1/50; E21B 2200/20

(57) ABSTRACT

Method is provided that can include operations for selecting one or more wellbores from a wellbore historical database, retrieving performance data for the one or more wellbores, determining performance indices of the one or more wellbores relative to wellbore depth based on the performance data, determining which of the one or more wellbores performed best at each depth based on the performance indices at each depth for a selected performance criteria, selecting the best performance at each depth from the one or more wellbores, and generating a composite well curve based on the best performance at each depth. A method is provided that can include operations for inputting performance data from multiple wellbores into a machine learning processor, processing the performance data based on a selected performance criteria, and generating an optimized composite well curve along with an optimized set of operational parameters for drilling a future wellbore.

### CROSS-REFERENCE TO RELATED APPLICATION(S)

This application claims priority under 35 U.S.C. § 119(e) to U.S. Provisional Application No. 63/373,249, entitled “COMPOSITE WELL CURVE GENERATION WITH MACHINE LEARNING,” by Malini MANOCHA et al., filed Aug. 23, 2022, which is assigned to the current assignee hereof and incorporated herein by reference in its entirety.

### FIELD OF THE DISCLOSURE

The present invention relates, in general, to the field of drilling and processing of wells. More particularly, present embodiments relate to a system and method for detecting states in previous subterranean operations, such as drilling and processing, analyzing the historical data of the subterranean operations, and generating a composite well curve for a future wellbore based on the historical data.

### BACKGROUND

During well construction operations, activities on a rig can be organized according to a well plan. The well plan can be converted to a rig plan (i.e., rig specific well construction plan) for implementation on a specific rig. Deviations from the well plan or rig plan can cause rig delays, and other impacts to operations. These deviations can be repeated in future well plans, especially if the future well plan is directed at forming a wellbore in a same or similar earth strata. Therefore, improvements in rig activity monitoring and reporting are continually needed.

### SUMMARY

This summary is provided to introduce a selection of concepts that are further described below in the detailed description. This summary is not intended to identify indispensable features of the claimed subject matter, nor is it intended for use as an aid in limiting the scope of the claimed subject matter. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method for generating a composite well curve. The method also includes storing, via a controller, performance data for multiple wellbores in a wellbore historical database, where the performance data can include operational parameters for rig equipment as well as operational states of the rig equipment; selecting, via the controller, one or more wellbores from the wellbore historical database; retrieving, via a machine learning processor (MLP), performance data for the one or more wellbores; analyzing, via the MLP, performance indices of the one or more wellbores relative to wellbore depth; determining, via the MLP, which of the one or more wellbores performed best based on the performance indices at each depth for a selected performance criteria; and selecting the best performance at each depth from the one or more wellbores; and generating a composite well curve based on the best performance at each depth. Other embodiments of this aspect include corresponding computer systems, apparatus, and computer programs recorded on one or more computer storage devices, each configured to perform the actions of the methods.

One general aspect includes a method for generating a composite well curve. The method also includes inputting performance data from multiple wellbores into a machine learning processor (MLP); processing, via the MLP, the performance data based on a selected performance criteria; and generating, via the MLP, an optimized composite well curve along with an optimized set of operational parameters for drilling a future wellbore based on selecting high performing sections from the multiple wellbores and assembling the high performing sections together into the optimized composite well curve. Other embodiments of this aspect include corresponding computer systems, apparatus, and computer programs recorded on one or more computer storage devices, each configured to perform the actions of the methods.

Implementations can include one or more of the following features. The method where the optimized composite well curve can include advisory messages used to inform a user of pertinent information about an occurring or soon to occur issue. The optimized composite well curve is generated to construct a wellbore while maintaining an effective ROP. The optimized composite well curve is generated to construct a wellbore in a shortest period of time. Implementations of the described techniques can include hardware, a method or process, or computer software on a computer-accessible medium.

One general aspect includes a method for generating a composite well curve. The method also includes selecting, via a controller, one or more wellbores from a wellbore historical database; retrieving, via a machine learning processor (MLP), performance data for the one or more wellbores; determining, via the MLP, performance indices of the one or more wellbores relative to wellbore depth based on the performance data; determining, via the MLP, which of the one or more wellbores performed best at each depth based on the performance indices at each depth for a selected performance criteria; selecting the best performance at each depth from the one or more wellbores; and generating a composite well curve based on the best performance at each depth. Other embodiments of this aspect include corresponding computer systems, apparatus, and computer programs recorded on one or more computer storage devices, each configured to perform the actions of the methods.

One general aspect includes a method for generating a composite well curve. The method also includes inputting performance data from multiple wellbores into a machine learning processor (MLP); processing, via the MLP, the performance data based on a selected performance criteria; and generating, via the MLP, an optimized composite well curve along with an optimized set of operational parameters for drilling a future wellbore based on selecting high performing sections from the multiple wellbores and assembling high performing sections together into the optimized composite well curve. Other embodiments of this aspect include corresponding computer systems, apparatus, and computer programs recorded on one or more computer storage devices, each configured to perform the actions of the methods.

### BRIEF DESCRIPTION OF THE DRAWINGS

These and other features, aspects, and advantages of present embodiments will become better understood when the following detailed description is read with reference to the accompanying drawings in which like characters represent like parts throughout the drawings, wherein:

FIG. 1A is a representative simplified front view of a rig being utilized for a subterranean operation, in accordance with certain embodiments;

FIG. 1B is a representative simplified view of an individual (or user) using wearable devices for user input or identification, in accordance with certain embodiments;

FIG. 2 is a representative partial cross-sectional view of a rig being utilized for a subterranean operation, in accordance with certain embodiments;

FIG. 3 is a representative front view of various individuals identifiable via an imaging system, in accordance with certain embodiments;

FIG. 4A is a representative list of activities for an example digital well plan, in accordance with certain embodiments;

FIG. 4B is a representative functional diagram that illustrates the conversion of well plan activities to rig plan tasks, in accordance with certain embodiments;

FIG. 5 is a representative functional diagram that illustrates possible databases used by a rig controller to convert a digital well plan to a digital rig plan, in accordance with certain embodiments;

FIG. 6 is a representative functional diagram that illustrates converting a digital well plan to a digital rig plan and mitigating a detected dysfunction while executing the digital rig plan, in accordance with certain embodiments;

FIG. 7 is a representative functional diagram that illustrates using a rip plan engine and databases to convert a digital well plan to a digital rig plan, with the digital well plan including alternate activities for managing a dysfunction, in accordance with certain embodiments;

FIG. 8 is a representative high-level flow chart of generating a composite well curve from historical data of previously formed wellbores, in accordance with certain embodiments;

FIG. 9A is a representative plot 500 of a composite well curve 510, in accordance with certain embodiments;

FIG. 9B is a representative table of datasets that can be used to derive the plot 500 of the composite well curve 510 of FIG. 9A, in accordance with certain embodiments;

FIG. 10 is a representative plot 530 of performance indices 538 of rig performance for various wellbores, in accordance with certain embodiments;

FIG. 11 is a representative graphical user interface (GUI) 540 for selecting data and performance criteria for a machine learning processor (MLP), in accordance with certain embodiments; and

FIG. 12 and FIGS. 12A-12D illustrate a representative GUI for displaying a composite well curve 510 and visual representations of at least some of the historical data used by the machine learning processor (MLP), in accordance with certain embodiments.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but can include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about,” “approximately,” or “substantially” is intended to mean that a value of a parameter is close to a stated value or position. However, minor differences can prevent the values or positions from being exactly as stated. Thus, differences of up to ten percent (5%) for the value are reasonable differences from the ideal goal of exactly as described. A significant difference can be when the difference is greater than ten percent (5%).

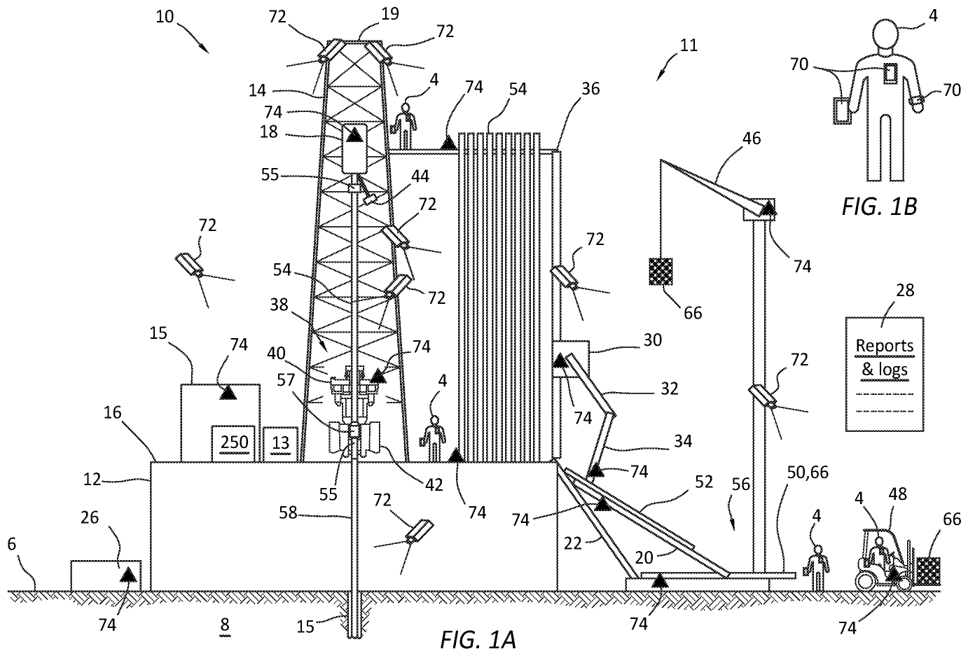

As used herein, “tubular” refers to an elongated cylindrical tube and can include any of the tubulars manipulated around a rig, such as tubular segments, tubular stands, tubulars, and tubular string, but not limited to the tubulars shown in FIG. 1A. Therefore, in this disclosure, “tubular” is synonymous with “tubular segment,” “tubular stand,” and “tubular string,” as well as “pipe,” “pipe segment,” “pipe stand,” “pipe string,” “casing,” “casing segment,” or “casing string.”

FIG. 1A is a representative simplified front view of a rig 10 at a rig site 11 being utilized for a subterranean operation (e.g., tripping in or out a tubular string to or from a wellbore, drilling a wellbore, casing a wellbore, etc.), in accordance with certain embodiments. The rig site 11 can include the rig 10 with its rig equipment, along with all support equipment and work areas that support the rig 10 but are not necessarily on the rig 10. The rig 10 can include a platform 12 with a rig floor 16 and a derrick 14 extending up from the rig floor 16. The derrick 14 can provide support for hoisting the top drive 18 as needed to manipulate tubulars. A catwalk 20 and V-door ramp 22 can be used to transfer horizontally stored tubular segments 50 to the rig floor 16. A tubular segment 52 can be one of the horizontally stored tubular segments 50 that is being transferred to the rig floor 16 via the catwalk 20. A pipe handler 30 with articulating arms 32, 34 can be used to grab the tubular segment 52 from the catwalk 20 and transfer the tubular segment 52 to the top drive 18, the fingerboard 36, the wellbore 15, etc. However, it is not required that a pipe handler 30 be used on the rig 10. The top drive 18 can transfer tubulars directly to and directly from the catwalk 20 (e.g., using an elevator coupled to the top drive).

The tubular string 58 can extend into the wellbore 15, with the wellbore 15 extending through the surface 6 into the subterranean formation 8. When tripping the tubular string 58 into the wellbore 15, tubulars 54 are sequentially added to the tubular string 58 to extend the length of the tubular string 58 into the earthen formation 8. FIG. 1A shows a land-based rig. However, it should be understood that the principles of this disclosure are equally applicable to off-shore rigs where “off-shore” refers to a rig with water between the rig floor and the earth surface 6.

When tripping the tubular string 58 out of the wellbore 15, tubulars 54 are sequentially removed from the tubular string 58 to reduce the length of the tubular string 58 in the wellbore 15. The pipe handler 30 can be used to remove the tubulars 54 from an iron roughneck 38 or a top drive 18 at a well center 24 and transfer the tubulars 54 to the catwalk 20, the vertical storage 36, etc. The iron roughneck 38 can break a threaded connection between a tubular 54 being removed and the tubular string 58. A spinner assembly 40 can engage a body of the tubular 54 to spin a pin end 57 of the tubular 54 out of a threaded box end 55 of the tubular string 58, thereby unthreading the tubular 54 from the tubular string 58.

When tripping the tubular string 58 into the wellbore 15, tubulars 54 are sequentially added to the tubular string 58 to increase the length of the tubular string 58 in the wellbore 15. The pipe handler 30 can be used to deliver the tubulars 54 to a well center on the rig floor 16 in a vertical orientation and hand the tubulars 54 off to an iron roughneck 38 or a top drive 18. The iron roughneck 38 can make a threaded connection between the tubular 54 being added and the tubular string 58. A spinner assembly 40 can engage a body of the tubular 54 to spin a pin end 57 of the tubular 54 into a threaded box end 55 of the tubular string 58, thereby threading the tubular 54 into the tubular string 58. The wrench assembly 42 can provide a desired torque to the threaded connection, thereby completing the connection.

While tripping a tubular string into and out of the wellbore 15 can be a significant part of the operations performed by the rig, many other well plan activities are also needed to perform a well construction according to a digital well plan. For example, pumping mud at desired rates, maintaining downhole pressures (as in managed pressure drilling), maintaining, and controlling rig power systems, coordinating, and managing personnel on the rig during operations, performing pressure tests on sections of the wellbore 15, cementing a casing string in the wellbore, performing well logging operations, as well as many other well plan activities. As used herein, a “digital well plan” refers to a list of activities to be performed to construct a specific wellbore 15 in an earthen formation 8. As used herein, a “digital rig plan” refers to a list of rig-specific tasks to be performed to execute the digital well plan on a specific rig. As used herein, “well curve” or “composite well curve” refers to a theoretical best progression of a wellbore 15 into a subterranean formation 8.

A rig controller 250 can be used to control the rig 10 operations including controlling various rig equipment, such as the pipe handler 30, the top drive 18, the iron roughneck 38, the fingerboard equipment, imaging systems, various other robots on the rig 10 (e.g., a drill floor robot), or rig power systems 26. The rig controller 250 can control the rig equipment autonomously (e.g., without periodic operator interaction,), semi-autonomously (e.g., with limited operator interaction such as initiating a subterranean operation, adjusting parameters during the operation, etc.), or manually (e.g., with the operator interactively controlling the rig equipment via remote control interfaces to perform the subterranean operation).

The rig controller 250 can include one or more processors with one or more of the processors distributed about the rig 10, such as in an operator's control hut, in the pipe handler 30, in the iron roughneck 38, in the vertical storage area 36, in the imaging systems, in various other robots, in the top drive 18, at various locations on the rig floor 16 or the derrick 14 or the platform 12, at a remote location off of the rig 10, at downhole locations, etc. It should be understood that any of these processors can perform control or calculations locally or can communicate to a remotely located processor for performing the control or calculations. Each of the processors can be communicatively coupled to a non-transitory memory, which can include instructions for the respective processor to read and execute to implement the desired control function. These processors can be coupled via a wired or wireless network. All data received and sent by the rig controller 250 is in a computer-readable format and can be stored in and retrieved from the non-transitory memory. One particular processor that can be included in the rig controller 250 is a machine learning processor (MLP) for generating a composite well curve for a future well construction.

The rig controller 250 can collect data from various data sources around the rig (e.g., sensors, user input, local rig reports, etc.) and from remote data sources (e.g., suppliers, manufacturers, transporters, company men, remote rig reports, etc.) to monitor and facilitate the execution of a digital well plan. A digital well plan is generally designed to be independent of a specific rig, where a digital rig plan is a digital well plan that has been modified to incorporate the specific equipment available on a specific rig to execute the well plan on the specific rig, such as rig 10. Therefore, the rig controller 250 can be configured to monitor and facilitate the execution of the digital well plan by monitoring and executing the digital rig plan. All the data from the various data sources can be stored as historical data when the well construction for the current wellbore 15 is completed. The data from the various data sources can be stored and used to determine performance indicators for the rig 10, the rig equipment, the operational parameters used during well construction, and for personnel supporting the execution of the digital rig plan.

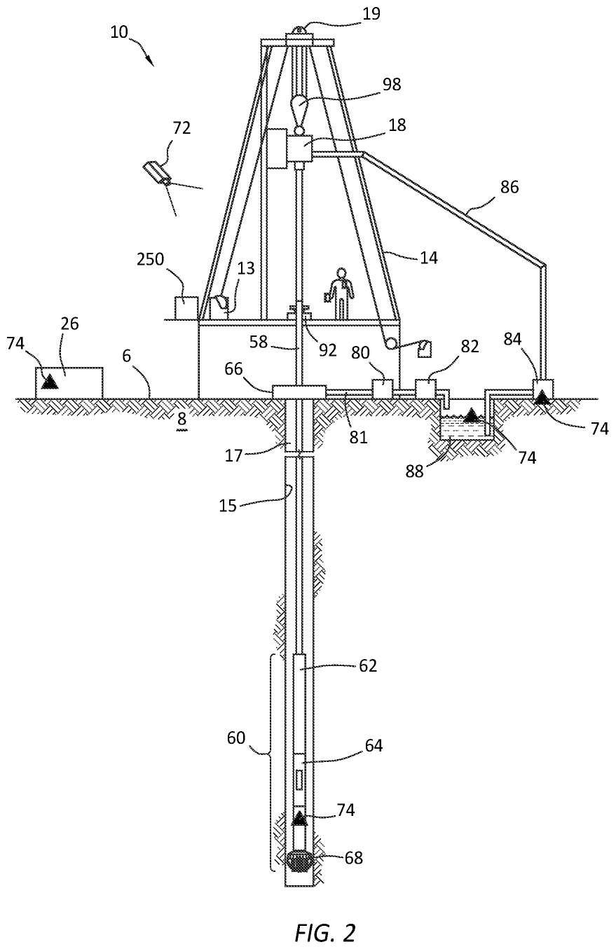

Examples of local data sources are shown in FIG. 1A where an imaging system can include the rig controller 250 and imaging sensors 72 positioned at desired locations around the rig and around support equipment/material areas, such as mud pumps (see FIG. 2), horizontal storage area 56, power system 26, etc., to collect imagery of the desired locations. Also, various sensors 74 can be positioned at various locations around the rig 10 and the support equipment/material areas to collect information from the rig equipment (e.g., pipe handler 30, roughneck 38, top drive 18, vertical storage 36, etc.), support equipment (e.g., crane 46, forklift 48, horizontal storage area 56, power system 26, etc.), and personnel to collect operational parameters of the equipment and the personnel. Additional information can be collected from other data sources, such as reports and logs 28 (e.g., tour reports, daily progress reports, reports from remote locations, shipment logs, delivery logs, personnel logs, third party well construction data, etc.).

The data sources can also include wearables 70 (e.g., a smart wristwatch, a smart phone, a tablet, a laptop, an identification badge, a wearable transmitter, augmented reality device, virtual reality device, etc.) that can be worn by an individual 4 (or user 4) to identify the individual 4, deliver instructions to the individual 4, or receive inputs from the individual 4 via the wearable 70 to the rig controller 250 (see FIG. 1B). Network connections (wired or wireless) to the wearables 70 can be used for communication between the rig controller 250 and the wearables 70 for information transfer.

These data sources can be aggregated by the rig controller 250 and used to determine one or more dysfunctions during the execution of the digital well plan as well as creating a composite well curve for a future well construction, via the MLP. As used herein, a “dysfunction” is an activity at a rig site 11 that causes the rig controller 250 to deviate from the current digital well plan or current digital rig plan. As used herein, the “current digital well plan” or “current well plan” refers to a well plan being executed when the dysfunction is detected (e.g., via analysis of data sources) or otherwise determined (e.g., user input, etc.). As used herein, the “current digital rig plan” or “current rig plan” refers to the rig plan being executed when the dysfunction is detected (e.g., via analysis of data sources) or otherwise determined (e.g., user input, etc.), where the rig plan is an implementation of the well plan on a specific rig (e.g., rig 10).

As used herein, the “future well plan” refers to a digital well plan that is created for construction of a wellbore in the future. As used herein, a “future well curve” refers to a composite well curve that is used to drive creation of the future well plan for constructing the future wellbore. As used herein, a “resulting well plan” refers to the final version of a digital well plan that has been completed, and the resulting well plan includes all modifications to the well plan that occurred while the well plan was being executed. The resulting well plan can omit alternative well plan activities that were not actually executed during execution of the well plan. However, the future well plan can still include these alternative activities (or alternative rig tasks) as pre-planned ways of managing any dysfunctions that can occur when construction the future well.

The dysfunction can be classified into at least three different categories. The dysfunction can be a “planned predictive dysfunction,” an “unplanned predictive dysfunction,” or an “unplanned reactive dysfunction.”

As used herein, a “planned predictive dysfunction” refers to one or more activities at a rig site (e.g., rig site 11) that were included in the digital well plan when the well plan was initially converted to a digital rig plan but were included as alternative activities in the well plan that can be selected for the execution if an anticipated (or planned) dysfunction is detected. Therefore, the one or more activities for managing the anticipated dysfunction are included in the well plan when it is converted to the rig plan, but the one or more activities can be selected for the execution in the well plan when the anticipated dysfunction is detected, or not selected for the execution in the well plan when the anticipated dysfunction is not detected.

Therefore, the possible need for the one or more activities to be included into the digital well plan (and thus the digital rig plan) was anticipated prior to conversion of the well plan to the rig plan. For example, when the well plan is created, the designer(s) can understand that it is possible (and maybe highly likely) that a fluid loss condition can occur at a certain depth (e.g., such as a salt layer in the earthen formation 8) and that entering this salt layer via a drill string can cause fluid loss to occur. Therefore, the designers can include well activities in the original well plan to handle the anticipated dysfunction (e.g., the fluid loss condition), but the well activities are included as alternative activities to be executed in response to the dysfunction being detected. If the planned dysfunction is not detected, then the well activities can be skipped and not executed.

Alternatively, the designers can provide a set of alternative well activities in a well activities database that can later be configured for a specific rig and inserted into the rig plan to handle the anticipated dysfunction if the anticipated dysfunction is detected. In this way, the designers can provide well activities that can manage the anticipated dysfunction without including the activities in the originally converted well plan. The designers can also alternatively, or in addition to, provide a set of rig-specific tasks to be directly inserted into the current digital rig plan to manage the anticipated dysfunction without providing well plan activities that can be converted to rig tasks of a digital rig plan.

As used herein, an “unplanned reactive dysfunction” refers to an unanticipated dysfunction that is detected by the rig controller 250 or individual 4 (local individual 4 being on the rig 10 or remote individual 4 being off the rig 10) and selecting a pre-planned set of rig tasks from a rig task database that can be inserted into the current digital rig plan to manage the unanticipated dysfunction. Alternatively, or in addition to, a pre-planned set of activities from a well plan activities database can be inserted into the current digital well plan and converted to rig-specific tasks to be inserted into the current digital rig plan to manage the unanticipated dysfunction. For example, when a fluid loss condition is detected at a depth that the fluid loss condition was not anticipated, a pre-planned set of rig tasks can be inserted into the current digital rig plan to manage the unanticipated fluid loss that occurs at a certain depth of the wellbore 15.

Additionally, for example, when a fluid kick condition is detected at a certain depth where the fluid kick condition was not anticipated, a pre-planned set of rig tasks can be inserted into the current digital rig plan to manage the unanticipated fluid kick that occurs at a certain depth of the wellbore 15. Additionally, for example, when an equipment failure is detected that directly impacts the execution of the digital well plan, then a pre-planned set of rig tasks can be inserted into the current digital rig plan to manage the unanticipated equipment failure. It should be understood that the pre-planned set of rig tasks can include a pre-planned set of rig tasks created directly by the rig controller 250 or an individual 4, or they can include a pre-planned set of rig tasks that was converted from a pre-planned set of well plan activities to a set of rig specific tasks. For example, if mud pumps 1 and 2 are supporting a drilling operation, but failure of mud pump 2 is detected (i.e., an “unplanned reactive dysfunction”), then rig tasks can be determined and inserted into the digital rig plan 102 to use mud pumps 1 and 3 instead of 1 and 2 to work around the dysfunction.

As used herein, an “unplanned predictive dysfunction” refers to an unanticipated dysfunction that is detected by the rig controller 250 or individual 4 (local individual 4 being on the rig 10 or remote individual 4 being off the rig 10) and the unanticipated dysfunction is determined to occur in the near future. A pre-planned set of rig tasks for managing the unplanned dysfunction can be retrieved, via the rig controller 250, from a rig task database and inserted into the current digital rig plan at an appropriate future time prior to the unplanned dysfunction occurring but does not have to alter the current rig plan immediately. The pre-planned set of rig tasks can be executed at the appropriate time in the future to manage the unanticipated dysfunction that has been predicted to happen in the near future (e.g., within the next week). Since the dysfunction is determined to occur prior to the dysfunction actually occurring, the dysfunction can be seen as being predicted prior to its occurrence. However, the unplanned predictive dysfunction can be seen as a dysfunction that was not highly anticipated or seen as likely to happen at the time the well plan was converted to the rig plan.

Alternatively, or in addition to, a pre-planned set of activities from a well plan activities database can be inserted into the current digital well plan and converted to rig-specific tasks which can be inserted into the current digital rig plan at an appropriate future time prior to the unplanned dysfunction occurring. The unplanned dysfunction can be detected by the rig controller 250 or individual 4 and can be managed at a later time. It does not impact the current execution of the current digital rig plan tasks. For example, when a mud motor status indicates to the rig controller 250 or individual 4 that a future failure of the mud motor is predicted in the near future and that the one or more activities should be inserted into the digital well plan (and thus the digital rig plan) prior to a predicted timeframe of an occurrence of the dysfunction. For example, if mud pumps 1 and 2 are supporting a drilling operation, but a failure of mud pump 2 is predicted in the near future (i.e., an “unplanned predictive dysfunction”), then rig tasks can be determined and inserted into the digital rig plan 102 to use mud pumps 1 and 3 instead of 1 and 2 before mud pump 2 fails but the changes are not needed immediately since the failure is in the near future. Additionally, for example, when secondary activities (that are not included in the well plan activities but support timely execution of the well activities) are not being completed in a timely fashion (e.g., supply of tubulars running low, mud additives not available for upcoming mud conditioning activity, personnel not available for upcoming required task, etc.), then rig tasks can be added to the current rig plan to facilitate necessary work-arounds for the dysfunctions.

FIG. 2 is a representative partial cross-sectional view of a rig 10 being used to drill a wellbore 15 in an earthen formation 8. FIG. 2 shows a land-based rig, but the principles of this disclosure can equally apply to off-shore rigs, as well. The rig 10 can include a top drive 18 with a crown deck 19, a traveling block 98, and a drawworks 13 used to raise or lower the top drive 18. A derrick 14 extending from the rig floor, can provide the structural support of the rig equipment for performing subterranean operations (e.g., drilling, treating, completing, producing, testing, etc.). The rig can be used to extend a wellbore 15 through the earthen formation 8 by using a drill string 58 having a Bottom Hole Assembly (BHA) 60 at its lower end. Slips 92 in coordination with the top drive 18, the traveling block 98, and the drawworks 13 can trip in and trip out the tubular string 58. The BHA 60 can include a drill bit 68 and multiple drill collars 62, with one or more of the drill collars including instrumentation 64 for LWD and MWD operations. During drilling operations, drilling mud can be pumped from the surface 6 into the drill string 58 (e.g., via pumps 84 supplying mud to the top drive 18) to cool and lubricate the drill bit 68 and to transport cuttings to the surface via an annulus 17 between the drill string 58 and the wellbore 15. The drilling mud can also be designed and used for maintaining the integrity of the wellbore and pressure management, such as in over pressure or under pressure drilling.

The returned mud can be directed to the mud pit 88 through the flow line 81 and the shaker 80. A fluid treatment 82 can inject additives as desired to the mud to condition the mud appropriately for the current well activities and possibly future well activities as the mud is being pumped to the mud pit 88. The pump 84 can pull mud from the mud pit 88 and drive it to the top drive 18 to continue circulation of the mud through the drill string 58.

Sensors 74 and imaging sensors 72 can be distributed about the rig and downhole to provide information on the environments in these areas as well as operating conditions, health of equipment, well activity of equipment, fluid properties, WOB, ROP, RPM of drill string, RPM of drill bit 68, etc.

The following operational parameters can be captured and logged for the wellbore(s) constructed via the digital well plan. Each completed wellbore will have a resulting well plan and these operational parameters recorded for review and creation of a future well curve for a future wellbore construction. These parameters (collected during execution of the digital well plan) can comprise one or more of an operational state (such as any of the International Association of Drilling Contractors IADC codes), Total Depth TotD (ft), true vertical depth TVD (ft), time log (e.g., seconds, minutes, hours, days), tubular string revolutions per minute (RPM), Mud Flow In (gal/min), rate of penetration ROP (ft/min), Weight on bit WOB (klbs), Pump Pressure (psi), Top Drive Torque (ft-lbs), bottom hole assembly (BHA) parameters (total length, drill bit parameters, mud motor parameters, etc.), mud parameters (e.g., mud weight, pressure gradient, viscosity, solids percentage, etc.), a performance goal, Hook load (klbs), Bit Depth BD (ft), Top Drive RPM, On Bottom (Y/N), Slips Set (Y/N), Operations Summary, Tour Sheet report, Mud Record report, Bit Record report, tubular parameters, formation information (e.g., depth information for subterranean formation 8 strata layers, UCS logs, etc.), combinations thereof, as well as other parameters not specifically mentioned here but well known in the industry.

These operational parameters can be used to train a machine learning processor (MLP) such that the MLP can learn the interrelationships between these operational parameters and can compare performance of a rig 10 drilling a first wellbore to one or more other rigs 10 drilling one or more other wellbores. The MLP can determine performance indices for rig operations performed during execution of a digital well plan and can create an optimal composite well curve for a future wellbore construction based on historical data (i.e., operational parameters) collected during construction of the previous wellbores.

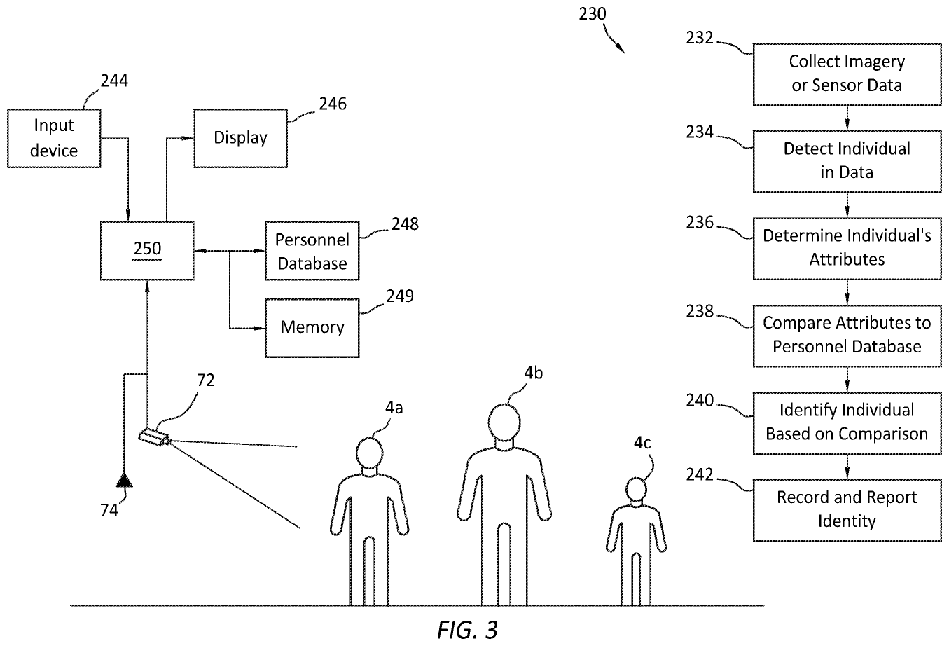

FIG. 3 is a representative front view of various users 4a, 4b, 4c that can be detectable via an imaging system. The imaging system can include the rig controller 250 and one or more imaging sensors 72 and possibly audio sensors 74 as well. When determining the current well activity, it can be beneficial to detect how many individuals are present on the rig, where they are, who they are, and what they are doing. For example, one or more imaging sensors 72 can be used to detect individuals on the rig, track their location as they move about the rig, and determine the identity of each of the individuals. By receiving imagery from the one or more imaging sensors 72, the rig controller 250 can perform image recognition to detect the individuals (such as individuals 4a, 4b, 4c) in the imagery. The rig controller 250 can also determine where each of the individuals are on the rig based on identification of the surroundings around the individuals in the imagery. The rig controller 250 can also determine the identity of each individual by determining attributes of the individual 4, where the attributes can include physical characteristics, mannerisms, walking motion, and voice (e.g., via audio sensors 74 included in the imaging system). The collected data can then be compared against a personnel database 248 to determine the unique identity of each individual 4. The rig controller 250 can record, report, or display the individual's 4 identity. An input device 244 can be used to provide input to the rig controller 250, such as to request identity verification or determination of an individual 4.

The method 230 illustrates a representative flow diagram for using the rig controller 250 to determine an identity of an individual 4 at the rig site. At operation 232, the rig controller 250 can autonomously (or as a result of a user request) collect imagery or other sensor data of one or more individuals 4 at the rig site via the imaging sensor(s) 72 or other sensors 74. At operation 234, the rig controller 250 can detect the one or more individuals in the imagery or sensor data. In operation 236, the rig controller 250 can analyze the imagery or sensor data to determine the attributes of the individual 4. In operation 238, the rig controller 250 can compare the determined attributes to attributes in a personnel database 248. In operation 240, rig controller 250 can identify the individual 4 based on the comparison of the attributes. In operation 242, rig controller 250 can record the individual's identity and report the identity to interested users/individuals. With the identity of each of the individuals determined, the rig controller 250 can compare the actual individuals with the well plan and can use the comparison to improve the confidence level of the estimated well activity.

After determining the unique identity of each individual 4, the rig controller 250 can determine the expertise/skills and experience level of the individual such as from a lookup table stored in non-transitory memory 249 which can be communicatively coupled to the rig controller 250. By knowing the unique identity of the individual, their skill set, and their location on the rig or in support areas, the rig controller 250 can assimilate this information along with the data from other various data sources to better determine the estimated well activity (or rig operation state). If the estimated well activity is an expected well activity when compared to the digital well plan, then expected progress is likely being made in executing the digital well plan.

The who and where information of each individual 4 supporting the rig 10 can also be used to verify that the secondary operations are being performed in a timely manner so they do not become a primary activity. As used herein “primary activities” are those activities that are listed in the digital well plan, and as used herein “secondary operations” are those operations that provide support for the execution of the primary activities. Secondary operations can become primary activities if they do not adequately support the primary activities and cause delays in the primary activities by not being able to properly execute the primary activities.

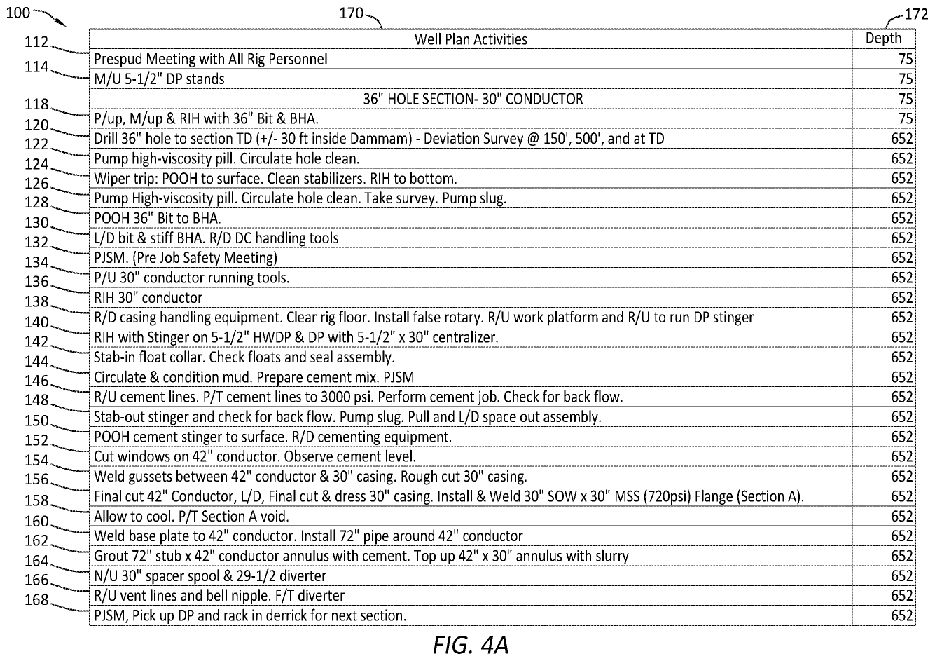

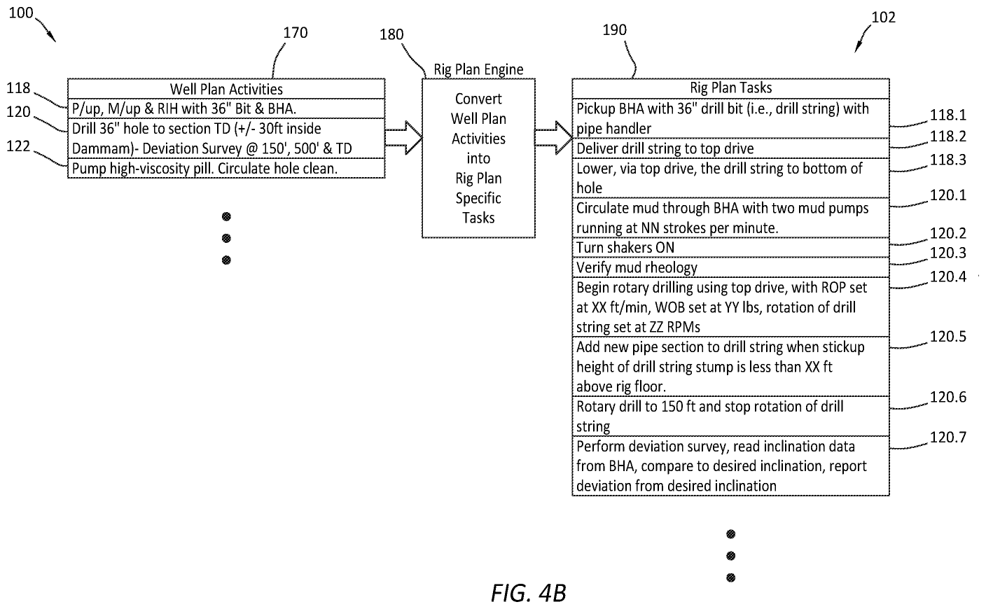

FIG. 4A is a representative list of activities 170 for an example digital well plan 100. This list of well plan activities 170 can merely represent a subset of a complete list of activities needed to execute a full digital well plan 100 to construct a wellbore 15 to a target depth (TD). The digital well plan 100 can include well plan activities 170 with corresponding target wellbore depths 172. However, these specific activities 170 are not required for the digital well plan 100. More or fewer activities 170 can be included in the digital well plan 100 in keeping with the principles of this disclosure. Therefore, the following discussion relating to the well plan activities 170 shown in FIG. 4A is merely an example to illustrate the concepts of this disclosure.

After the rig 10 has been utilized to drill the wellbore 15 to a depth of 75, at activity 112, a Prespud meeting can be held to brief all rig personnel on the goals of the digital well plan 100.

At activity 114, the appropriate personnel and rig equipment can be used to make-up (M/U) 5½″ drill pipe (DP) stands in prep for the upcoming drilling operation. This can for example require a pipe handler and horizontal or vertical storage areas for tubular segments or tubular stands. The primary activities can be seen as the make-up of the drill pipe (DP) stands, with the secondary operations being, for example, availability of tubular segments to build the DP stands; availability of a pipe handler (e.g., pipe handler 30) to manipulate the tubulars; a torquing wrench and backup tong for torquing joints when assembling the DP stands, a horizontal storage area, a vertical storage area; available space in a storage area for the DP stands; doping compound and doping device available for cleaning and doping threads of the tubulars 50; or appropriate personnel to support these operations.

At activity 118, the appropriate personnel and rig equipment can be used to pick up (P/up), makeup (M/up), and run-in hole (RIH) a BHA with a 36″ drill bit 68. This can, for example, require BHA components; a pipe handler to assist in the assembly of the BHA components; a pipe handler to deliver BHA to a top drive; and lowering the top drive to run the BHA into the wellbore 15. The primary activities can be seen as assembling the BHA and lowering the BHA into the wellbore 15. The secondary operations can be delivering the BHA components, including the drill bit, to the rig site; monitoring the health of the equipment to be used; and ensuring personnel available to perform tasks when needed.

At activity 120, the appropriate personnel and rig equipment can be used to drill 36″ hole to a TD of the section, such as 652 ft, to +/−30 ft inside a known formation layer (e.g., Dammam), and performing a deviation survey at depths of 150′, 500′ and TD (i.e., 652′ in this example). The primary activities can be seen as repeatedly feeding tubulars (or tubular stands 54) via a pipe handler to the well center from a tubular storage for connection to a tubular string 58 in the wellbore 15; operating the top drive 18, the iron roughneck 38, and slips to connect tubulars 50 (or tubular stands 54) to the tubular string 58; cleaning and doping threads of the tubulars 50, 54; running mud pumps to circulate mud through the tubular string 58 to the bit 68 and back up the annulus 17 to the surface; running shakers; injecting mud additives to condition the mud; rotating the tubular string 58 or a mud motor (not shown) to drive the drill bit 68, and performing deviation surveys at the desired depths.

The secondary operations can be seen as having tubulars 50 (or tubular stands 54) available in the horizontal storage or vertical storage locations and accessible via the pipe handler. If coming from the horizontal storage 56, then the tubulars 50 can be positioned on horizontal stands, with individuals 4 operating handling equipment, such as forklifts 48 or crane 46, to keep the storage area 56 stocked with the tubulars 50. If coming from the vertical storage 36, then the rig personnel 4 (or rig controller 250), can make sure that enough tubular stands 54 (or tubulars 50) are racked in the vertical storage 36 and accessible to the pipe handler 30 (or another pipe handler if needed). Additional secondary operations can be seen as ensuring that the doping compound and doping device are available for cleaning and doping threads of the tubulars 50; mud additives are available for an individual 4 (e.g., mud engineer) or an automated process to condition the mud as needed; the necessary equipment is available and operational to support the activity 120, such as the top drive 18 (including drawworks), iron roughneck 38, slips, and pipe handlers; and ensuring the power system 26 is configured to support the drilling operation.

At activity 122, the appropriate personnel and rig equipment can be used to pump a high-viscosity pill through the wellbore 15 via the tubular string 58 and then circulate wellbore 15 clean. The primary activities can be seen as injecting mud additives into the mud to create the high-viscosity pill, mud pumps operating to circulate the pill through the wellbore 15 (down through the tubular string 58 and up through the annulus 17); slips to hold tubular string 58 in place; top drive 18 connected to tubular string 58 to circulate mud; and, after pill is circulated, circulating mud through the wellbore 15 to clean the wellbore 15. The secondary operations can be ensuring the power system 26 is configured to support the mud circulation activities; the mud pumps 84 are configured to supply the desired pressure and flow rate of fluid to the tubular string 58; and that the mud additives are available for an individual 4 (e.g., mud engineer) or an automated process to condition the mud as needed.

At activity 124, the appropriate personnel and rig equipment can be used to perform a “wiper trip” by pulling the tubular string 58 out of the hole (Pull out of hole—POOH) to the surface 6; clean stabilizers on the tubular string 58; and run the tubular string 58 back into the hole (Run in hole—RIH) to the bottom of the wellbore 15. The primary activities can be seen as operating the top drive 18, the iron roughneck 38, and slips to disconnect tubulars 50 (or tubular stands 54) from the tubular string 58; moving the tubulars 50 (or tubular stands 54) to vertical storage 36 or horizontal storage 56 via a pipe handler, equipment and personnel/individuals 4 to clean the stabilizers; and operating the top drive 18, the iron roughneck 38, and slips to again connect tubulars 50 (or tubular stands 54) to the tubular string 58 while running the tubular string 58 back into the wellbore 15.

The secondary operations can be seen as having the necessary equipment to support the activity 124 is operational, such as the top drive 18 (including drawworks), iron roughneck 38, slips, and pipe handlers operational; ensuring the power system 26 is configured to support the tripping out and tripping in operations; and ensuring that the appropriate individual(s) 4 and cleaning equipment are available to perform stabilizer cleaning when needed.

At activities 126 thru 168, the appropriate personnel and rig equipment can be used to perform the indicated well plan activities. The primary activities can be seen as the personnel, equipment, or materials needed to directly execute the well plan activities using the specific rig 10. The secondary operations can be those activities that ensure the personnel, equipment, or materials are available and configured to support the primary activities.

FIG. 4B is a functional diagram that can illustrate the conversion of well plan activities 170 to rig plan tasks 190 of a rig-specific digital rig plan 102. When a well plan 100 is designed, well plan activities 170 can be included to describe primary activities needed to construct a desired wellbore 15 to a TD. However, the well plan 100 activities 170 are not specific to a particular rig, such as rig 10. It can be inappropriate to use the well plan activities 170 to direct operations on a specific rig, such as rig 10. Therefore, a conversion of the well plan activities 170 can be performed to create a list of rig plan tasks 190 of a digital rig plan 102 to construct the desired wellbore 15 using a specific rig, such as rig 10. This conversion engine 180 (which can run on a computing system such as the rig controller 250) can take the non-rig specific well plan activities 170 as an input and convert each of the non-rig specific well plan activities 170 to a series of rig specific tasks 190 to create a digital rig plan 102 that can be used to direct activities on a specific rig, such as rig 10, to construct the desired wellbore 15.

As way of example, a high-level description of the conversion engine 180 will be described for a subset of well plan activities 170 to demonstrate a conversion process to create the digital rig plan 102. The well plan activity 118 states, in abbreviated form, to pick up, make up, and run-in hole a BHA 60 with a 36″ drill bit. The conversion engine 180 can convert this single non-rig-specific activity 118 into, for example, three rig-specific tasks 118.1, 118.2, 118.3. Task 118.1 can instruct the rig operators or rig controller 250 to pick up the BHA 60 (which has been outfitted with a 36″ drill bit) with a pipe handler. At task 118.2, the pipe handler can carry the BHA 60 and deliver it to the top drive 18, with the top drive 18 using an elevator to grasp and lift the BHA 60 into a vertical position. At task 118.3, the top drive 18 can lower the BHA 60 into the wellbore 15 which has already been drilled to a depth of 75′ for this example as seen in FIG. 4A. The top drive 18 can lower the BHA 60 to the bottom of the wellbore 15 to have the drill bit 68 in position to begin drilling as indicated in the following well activity 120.

The well plan activity 120 states, in abbreviated form, to drill a 36″ hole to a target depth (TD) of the section, such as 652 ft, to +/−30 ft inside a known formation layer (e.g., Dammam), and performing a deviation survey at depths of 150′, 500′ and TD (i.e., 652′ in this example). The conversion engine 180 can convert this single non-rig-specific activity 120 into, for example, seven rig-specific tasks 120.1 to 120.7. Task 120.1 can instruct the rig operators or rig controller 250 to circulate mud through the top drive 18, through the drill string 58, through the BHA 60, and exiting the drill string 58 through the drill bit 68 into the annulus 17. For this example, the mud flow requires two mud pumps 84 to operate at “NN” strokes per minute, where “NN” is a desired value that delivers the desired mud flow and pressure. At task 120.2, the shaker tables can be turned on in preparation for cuttings that should be coming out of the annulus 17 when the drilling begins. At task 120.3, a mud engineer can verify that the mud characteristics are appropriate for the current tasks of drilling the wellbore 15. If the rheology indicates that mud characteristics should be adjusted, then additives can be added to adjust the mud characteristics as needed.

At task 120.4, rotary drilling can begin by lowering the drill bit into contact with the bottom of the wellbore 15 and rotating the drill bit by rotating the top drive 18 (e.g., rotary drilling). The drilling parameters can be set to be “XX” ft/min for rate of penetration (ROP), “YY” lbs for weight on bit (WOB), and “ZZ” revolutions per minute (RPM) of the drill bit 68.

At task 120.5, as the wellbore 15 is extended by the rotary drilling, when the top end of the tubular string 58 is less than “WW” ft above the rig floor 16, then a new tubular segment (e.g., tubular, tubular stand, etc.) can be added to the tubular string 58 by retrieving a tubular segment 50, 54 from tubular storage via a pipe handler, stop mud flow and disconnect the top drive from the tubular string 58, hold the tubular string 58 in place via the slips at well center, raise the top drive 18 to provide clearance for the tubular segment to be added, transfer tubular segment 50, 54 from the pipe handler 30 to the top drive 18, connect the tubular segment 50, 54 to the top drive 18, lower the tubular segment 50, 54 to the stump of the tubular string 58 and connect it to the tubular string 58 using a roughneck to torque the connection, then start mud flow. This can be performed each time the top end of the tubular string 58 is lowered below “WW” ft above the rig floor 16.

At task 120.6, add tubular segments 50, 54 to the tubular string 58 as needed in task 120.5 to drill wellbore 15 to a depth of 150 ft. Stop rotation of the drill bit 68 and stop mud pumps 84.

At task 120.7, perform a deviation survey by reading the inclination data from the BHA 60, comparing the inclination data to expected inclination data, and report deviations from the expected. Correct drilling parameters if deviations are greater than a pre-determined limit.

The conversion from a well plan 100 to a rig-specific rig plan 102 can be performed manually or automatically with the best practices and equipment recipes known for the rig that can be used in the wellbore construction.

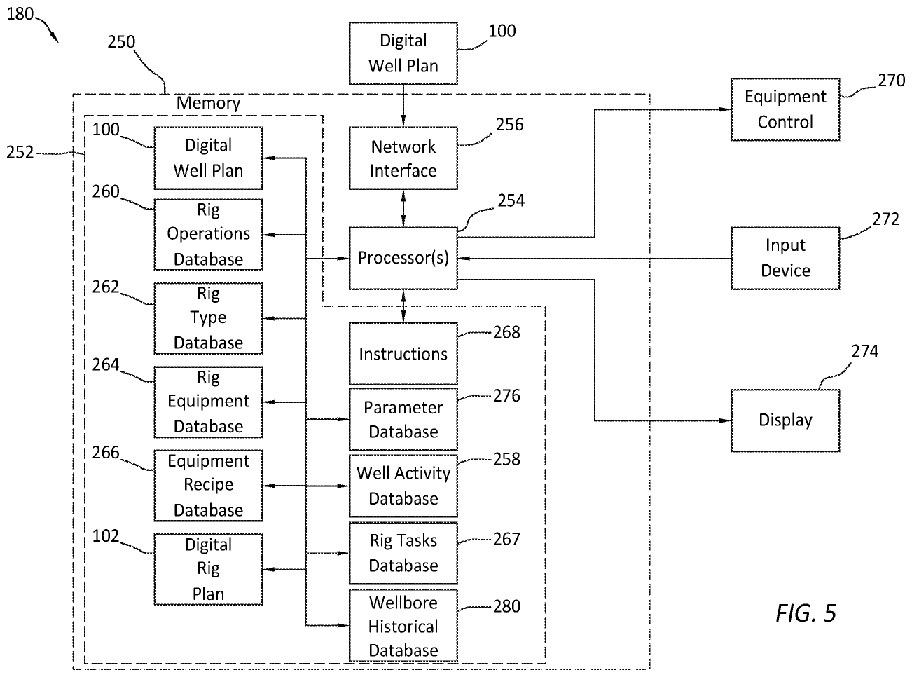

FIG. 5 is a representative functional diagram of the conversion engine 180 that can include possible databases used by a rig controller 250 to convert a digital well plan to a digital rig plan. The conversion engine 180 can be a program (i.e., list of instructions 268) that can be stored in the non-transitory memory 252 and executed by processor(s) 254 of the rig controller 250 to convert a digital well plan 100 to a digital rig plan 102.

A digital well plan 100 can be received at an input to the rig controller 250 via a network interface 256. The digital well plan 100 can be received by the processor(s) 254 and stored in the memory 252. The processor(s) 254 can then begin reading the sequential list of well plan activities 170 of the digital well plan 100 from the memory 252. The processor(s) 254 can process each well plan activity 170 to create rig-specific tasks to implement the respective activity 170 on a specific rig (e.g., rig 10).

To convert each well plan activity 170 to rig-specific activities for a rig 10, processor(s) 254 must determine the equipment available on the rig 10, the best practices, operations, and parameters for running each piece of equipment, and the operations to be run on the rig to implement each of the well plan activities 170.

Referring again to FIG. 5, the processor(s) 254 are communicatively coupled to the non-transitory memory 252 which can store multiple databases for converting the well plan 100 into the rig plan 102. A rig operations database 260 includes rig operations for implementing each of the well plan activities 170. Each of the rig operations can include one or more tasks to perform the rig operation. The processor(s) 254 can retrieve those operations for implementing the first rig activity 170 from the rig operations database 260 including the task lists for each operation. The processor(s) 254 can receive a rig type RT from a user input or the network interface 256. With the rig type RT, the processor(s) 254 can retrieve a list of equipment available on the rig 10 from the rig type database 262, which can contain equipment lists for a plurality of rig types.

The processor(s) 254 can then convert the operation tasks to rig-specific tasks to implement the operations on the rig 10. The rig-specific tasks can include the appropriate equipment for rig 10 to perform the operation task. The processor(s) 254 can then collect the recipes for operating each of the available equipment for rig 10 from the recipes database 266, where the recipes can include best practices on operating the equipment, preferred parameters for operating the equipment, and operational tasks for the equipment (such as turn ON procedures, ramp up procedures, ramp down procedures, shutdown procedures, etc.). The rig controller 250 can also retrieve parameters for the recipes from a separate parameters database 276, where these parameters can be the preferred parameters for operating the rig equipment using the recipes from the recipes database 266.

Therefore, the processor(s) 254 can retrieve each of the well plan activities 170 and convert them to a list of rig-specific tasks that can perform the respective well plan activity 170 on the rig 10. After converting all of the well plan activities 170 to rig specific tasks 190 and creating a sequential list of the tasks 190, the processor(s) 254 can store the resulting digital rig plan 102 in the memory 252. When the rig 10 is operational and positioned at the proper location to drill a wellbore 15, the rig controller 250, via the processor(s) 254, can begin executing the list of tasks in the digital rig plan 102 by sending control signals and messages to the equipment control 270.

The well plan 100 received initially at the rig controller 250 can include alternate activities that can be selected by the rig controller 250 or an individual 4 to manage a dysfunction that was understood by the designers of the well plan to be highly likely in the execution of the well plan 100 (i.e., a planned predictive dysfunction). These activities can be included in the well plan 100 with the other well plan activities 170 and the well plan 100 is converted to the rig-specific digital rig plan 102. The corresponding rig tasks 190 for these alternative activities can be embedded in the digital rig plan 102 to be available in case the planned predictive dysfunction occurs.

The rig controller 250 can also convert additional well plan activities via the same process when it receives the additional well plan activities during execution of the digital rig plan (e.g., to manage unplanned dysfunctions as they occur (reactive) or prior to their occurrence (predictive)). Additionally, the rig controller 250 can include databases of pre-planned activities and tasks that can be used to perform additional well activities that can arise during execution of the digital rig plan 102. For example, the well activity database 258 can include pre-planned activities for performing desired processes or actions, such as tripping in a tubular string, tripping out a tubular string, clean well, reem well, perform wellbore tests, etc. Therefore, if the rig controller 250 needs to perform a desired process or action, then the rig controller 250 can select the one or more well activities from the database 258, convert the one or more well activities to rig-specific tasks, and inject the rig-specific tasks into the current digital rig plan 102.

It should be understood that to perform a desired process or action, the rig controller 250 can also retrieve from a rig tasks database 267 a list of rig-specific tasks that have already been converted from well activities and stored in the rig tasks database 267. This allows the rig controller 250 to bypass the conversion process when adding new tasks to the digital rig plan when the database 267 already contains the task list for performing the desired process or action that was not originally included in the well plan 100 near the current activity in the current well plan 100.

There can also be multiple well activities or lists of rig tasks that can perform the desired process or action on the rig 10. Therefore, the rig controller 250 can use a performance index associated with each of the well activities or lists of rig tasks to determine which might be the best choice for performing the desired process or action on the rig. The rig controller 250 can update the performance index each time the well activity or list of rig tasks are used and therefore, continually update the performance indices. The list of rig tasks in the rig task database can also include the preferred parameters and best practices for operating the rig equipment.

As used herein, a “performance index” indicates a performance of the rig 10 (or rig equipment) to successfully execute the digital rig plan 102 or produce a desired ROP for the drilling operation. The performance index can be a profile of performance indices of the rig 10 along the wellbore and correlated to a depth (or depth range) of the wellbore. The performance data can be associated with the operational parameters of the rig 10 that are attributed to the resulting performance index as well as operational states of the rig equipment.

The rig controller 250 can also receive user input from an input device 272 or display information to a user or individual 4 via a display 274. The input device 272 in cooperation with the display 274 can be used to input well plan activities, initiate processes (such as converting the digital well plan 100 to the digital rig plan 102), select alternative activities, or rig tasks during execution of digital well plan 100 or digital rig plan 102, or monitor operations during well plan execution.

Once the well plan 100 (or rig plan 102) is executed and the rig operations of the rig 10 completed (e.g., including rig up, subterranean operations, rig down, rig move, etc.), the rig controller 250 (or individual processor) can store the complete record (or at least a portion) of the well construction operation including a chronology of rig tasks and well construction data in a wellbore historical database 280. The well construction data can include, but not limited to; how, when, and where specific equipment, personnel, and parameters are used to execute each task; the mud rheology for each task; material specifications for equipment used in each task; performance goals for each task; performance indices for each task; BHA details for each task; formation measurement data; survey data; as well as other particular data used or generated during construction of the wellbore 15.

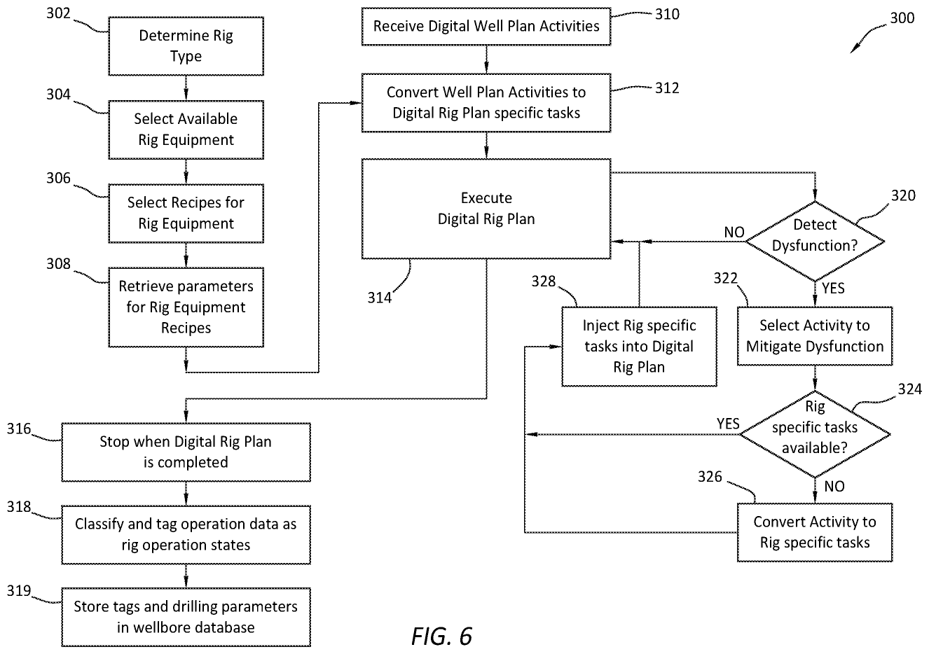

FIG. 6 is a representative functional diagram that illustrates a method 300 for converting a digital well plan 100 to a digital rig plan 102 and mitigating a detected dysfunction while executing the digital rig plan 102. At operation 310, the rig controller 250 can receive the activities from the digital well plan 100. At operation 302, the rig controller 250 can receive the rig type RT, and in operation 304 use the rig type to select the list of available rig equipment from the rig type database 262. In operation 306, the rig controller 250 can retrieve recipes for operating the available rig equipment from the recipes database 266. In operation 308, the rig controller 250 can retrieve operating parameters for the recipes from the recipes database 266 or from a separate parameters database 276. In operation 312, the rig controller 250 can use the available rig equipment for the rig type and the recipes for operating the available rig equipment to convert the digital well plan 100 activities 170 to digital rig plan 102 tasks 190 along with operations collected from the rig operations database 260 for performing each activity 170.

In operation 314, the rig controller 250 can begin executing the digital rig plan 102. During execution of the digital rig plan 102, the rig controller 250 can continuously (or at least periodically or on an as needed basis) receive data from the multiple data sources and aggregate the data to determine the current state of the rig operations, the current activity of the well plan 100 being performed, the current rig task being performed, the adherence of the current well activity to track the expected performance of the digital well plan 100. For example, if the current well activity is a planned well activity or an unplanned or unexpected well activity at the current time. In operation 320, the rig controller 250 can monitor the health of the rig operations and detect a dysfunction that can be occurring or will occur in the near future. If a dysfunction is not detected, then the execution of the digital rig plan 102 can continue with the rig controller 250 proceeding back to operation 314. However, if a dysfunction is detected, then the rig controller 250 can proceed to operation 322.

In operation 322, the rig controller 250 can select one or more well activities 170 that can be used to mitigate (or manage) the dysfunction so the rig controller 250 can return to executing the digital rig plan 102 once the dysfunction is mitigated. It should be noted that the one or more well activities 170 can be pre-planned well activities 170 that were included in the initial digital well plan 100 prior to conversion to the digital rig plan 102. Therefore, the rig-specific tasks 190 for implementing the pre-planned well activities 170 can already be available in the digital rig plan 102. Therefore, the rig controller 250 (or individual 4) can initiate execution of the rig-specific tasks 190 for implementing the pre-planned well activities 170. As mentioned above, this can be seen as a planned predictive dysfunction that was initially anticipated.

If the detected dysfunction was not a planned predictive dysfunction, then it can possibly be an unplanned predictive dysfunction or an unplanned reactive dysfunction. If the dysfunction is an unplanned predictive dysfunction, then the rig controller 250 (or individual 4) can select one or more well activities 170 to mitigate the dysfunction. In operation 322, the rig controller 250 can check to see if there are already rig-specific tasks 190 in the rig tasks database 267 to implement the one or more well activities 170. If so, the rig controller 250 can inject the rig-specific tasks 190 (in operation 328) into the digital rig plan 102 for execution in operation 314. If not, the rig controller 250 can convert the one or more well activities 170 to rig specific tasks 190 (in operation 326) and inject the rig specific tasks 190 (in operation 328) into the digital rig plan 102 for execution in operation 314. However, injecting the rig-specific tasks 190 into the digital rig plan 102 does not require the rig controller 250 to immediately begin execution of the rig-specific tasks 190 to mitigate the dysfunction, since the dysfunction is an unplanned predictive dysfunction. The rig controller 250 can determine the best time to mitigate the dysfunction by selecting a start time for the execution of the rig-specific tasks 190 for mitigating the dysfunction. The rig controller 250 can continue to execute the digital rig plan 102 in operation 314 until the desired time (or start time) to mitigate the unplanned predictive dysfunction has come.

If the dysfunction is an unplanned reactive dysfunction, then the rig controller 250 (or individual 4) can select one or more well activities 170 to mitigate the dysfunction. In operation 322, the rig controller 250 can check to see if there are already rig-specific tasks 190 in the rig tasks database 267 to implement the one or more well activities 170. If so, the rig controller 250 can inject the rig-specific tasks 190 (in operation 328) into the digital rig plan 102 for execution in operation 314. If not, the rig controller 250 can convert the one or more well activities 170 to rig specific tasks 190 (in operation 326) and inject the rig specific tasks 190 (in operation 328) into the digital rig plan 102 for execution in operation 314. For this kind of dysfunction, execution of the digital rig plan 102 can already be impacted, so more often than not, the rig controller 250 can begin executing the rig specific tasks 190 for mitigating the dysfunction as soon as they are injected into the digital rig plan 102 in operation 328. When the digital rig plan 102 is completed and the wellbore 15 is drilled to its target depth TD, then the drilling operations on the rig 10 can stop in operation 316.

At completion of the wellbore 15, in operation 318, the complete record (or at least a portion) of the well construction data of the rig 10 operations can be classified and tagged per IADC codes and sub-codes. Table 1 below lists the high-level IADC codes for operational states of the rig 10. Classifying and tagging the well construction data can also include classifying and tagging sub-codes under the high-level codes. For example, the high-level IADC code for drilling is “02”. Table 2 below shows a possible list of first tier sub-codes under the drilling “02” high-level IADC code. Further tiers of IADC sub-codes are defined in the IADC guidelines and these high-level codes and sub-codes can be used to classify and tag (or label, mark, categorize, characterize, etc.) the well construction data for the wellbore 15 using the rig 10.

The well construction data can include, but not limited to; how, when, and where specific equipment, personnel, and parameters are used to execute each task of the rig plan 102; material specifications for equipment used in each task (e.g., tubulars, casing, cement, mud rheology, etc.); performance goals for each task; performance indices for each task; BHA details for each task; formation measurement data; survey data; as well as other particular data used or generated during construction of the wellbore 15.

TABLE 1
IADC codes for Rig Operation States can
at least include the following codes.

| Code | Operation State |
|---|---|
| 1 | RIG UP/TEAR DOWN/RIG MOVE |
| 2 | DRILLING |
| 3 | REAMING |
| 4 | CORING |
| 6 | TRIPS |
| 7 | SERVICE/MAINTAIN RIG |
| 8 | REPAIR RIG |
| 9 | REPLACING DRILL LINE |
| 10 | DEVIATION SURVEY |
| 11 | WIRELINE LOGS |
| 12 | RUN CASING & CEMENT |
| 13 | WAIT ON CEMENT |
| 14 | RIG UP/DOWN BOP |
| 15 | TEST BOP |
| 16 | DRILL STEM TEST |
| 17 | PLUG BACK |
| 18 | SQUEEZE CEMENT |
| 19 | FISHING |
| 20 | SPECIALIZED DIRECTIONAL WORK |
| 21 | RUN/RETRIEVE RISER EQUIP. |
| 22 | SURFACE TESTING |
| 23 | OTHER |
| 24 | NON-PRODUCTIVE TIME |
| 25 | OPERATING STATUS |
| 26 | SAFETY |
| 27 | WELL CONTROL |
| 28 | COILED TUBING |
| 29 | PERFORATING |
| 30 | TUBING TRIPS |
| 31 | TREATING & WELL COMPLETION |
| 32 | SWABBING |
| 33 | TESTING |
| 34 | SUBSEA INSTALLATIONS |

However, this disclosure is not limited to this list of IADC codes in Table 1. The IADC codes can be revised and modified to accommodate improvements in the art. The principles of this disclosure are not dependent upon the particular IADC codes, just that the IADC codes can be used to classify and tag the well construction data. It should be understood that any other code systems can be used to classify and tag the well construction data.

TABLE 2
IADC sub-codes for drilling.

| | IADC | |
|---|---|---|
| Major IADC Code | Sub-Code | Sub-Operation |
| CODE 02 DRILLING | 2.A | ROTARY DRILLING |
| | 2.B | SLIDE DRILLING |
| | 2.C | DRILLING CEMENT |
| | 2.D | HOLE OPENING |
| | 2.E | AIR - FOAM - MIST DRILLING |
| | 2.F | DRILLING |
| | | RATHOLE/MOUSEHOLE |
| | 2.G | MILLING |

In operation 319, the rig controller 250 (or individual processor) can store the complete record (or at least a portion) of the well construction data in a wellbore historical database 280. The well construction data can include the associated IADC codes (i.e., assigned in operation 318) and the rig controller 250 can store the well construction data in a manner that preserves the chronology of rig tasks as well as what parameters were used and when these parameters were used to execute the digital rig plan 102 to construct the wellbore 15.

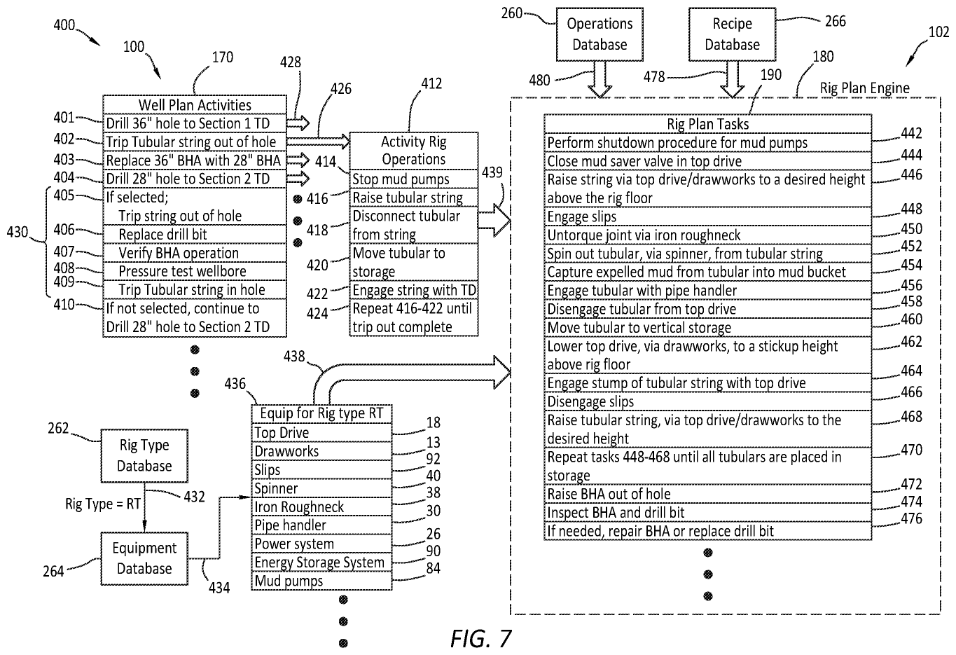

FIG. 7 is a representative functional diagram that illustrates a method 400 for using a conversion engine 180 and databases (e.g., 260, 262, 264, 266) to convert a digital well plan 100 to a digital rig plan 102, with the digital well plan 100 including alternate activities for managing a dysfunction. The rig controller 250 can receive the well plan activities 170 of the digital well plan 100 and retrieve 428 rig operations for performing each activity 170 (e.g., 401-410). The resulting group of rig operations can be converted, via the rig plan engine (possibly running on the rig controller 250), into the rig plan tasks 190 of the digital rig plan 102. As way of example, the well activity 402 can be converted to a list of rig operations 412 which are more detailed operations for performing the activity 402.

For example, the activity 402 can request to trip a tubular string 58 out of the hole (or wellbore 15). This request can require the more detailed operations (list 412) to perform the requested activity 402. For example, the list of rig operations 412 can include operation 414 which can stop the pumps 84 in preparation for disconnecting a tubular 50, 54 from the tubular string 58. Operation 416 can raise the tubular string 58, via the top drive 18, to a desired height that will allow disconnection and removal of the tubular 50, 54 from the tubular string 58. In operation 418, the iron roughneck 38 can be used to untorque the joint where the tubular 50, 54 is connected to the tubular string 58 and spin the tubular 50, 54 from the tubular string 58. In operation 420, a pipe handler 30 can collect the tubular 50, 54 from either the iron roughneck 38 or the top drive 18 and move the tubular 50, 54 to a storage location (e.g., vertical storage 36 or horizontal storage 56). In operation 422, the top drive can then be lowered to engage the stump of the tubular string 58 (which can be sticking out just above the rig floor 16 at well center). As stated in operation 424, operations 416 thru 422 can be repeated as needed until the tubular string 58 has been tripped out of the hole (or wellbore 15). The lists of rig operations (e.g., list 412) can be input into the conversion engine 180 for conversion to the rig plan tasks 190 of the rig plan 102 for constructing a desired wellbore 15 using the rig 10.

The rig controller 250 can receive the rig type RT and based on the rig type RT identify which of the rig equipment in the equipment database 264 are available on the rig 10. An example of the available equipment for rig 10 based on the rig type RT is shown in the equipment list 436. These are only examples of equipment that can be included with rig 10, but it should be understood that this disclosure is not limited to the equipment listed in the list 436. More or fewer pieces of equipment can be available for rig 10. The list of available equipment 436 can also be input into the conversion engine 180 for conversion to the rig plan tasks 190 of the rig plan 102 for constructing a desired wellbore 15 using the rig 10.

As stated above, the conversion engine 180 can use the rig operations (e.g., list 412), the list of available rig equipment 436, and the recipe database 266 to convert the rig operations into the rig plan tasks 190 for implementing the rig operations on the rig 10. This can be done initially when the original digital well plan 100 is converted into the digital rig plan 102, or it can be done after the execution of the digital rig plan 102 has begun, and, for example, a dysfunction is detected. In this case, the well plan activities can be those activities needed to mitigate the dysfunction. The conversion engine 180 can also collect operations directly from the operations database 260 to be converted into rig plan tasks 190, for example, to mitigate detected dysfunctions.

In the current example illustrated in FIG. 7, the list 412 of rig operations 414 thru 424 can be converted into the rig plan tasks 442 thru 476. It should be understood that this list of rig tasks 190 for performing the list of operations 412 are merely examples of the tasks that can be used. More or fewer tasks can be used to perform this list of operations 412.

The previous discussion is generally related to creating a digital rig plan 102 from a digital well plan 100 and executing the digital rig plan 102. However, this discussion provides limited insight into the creation of a well curve that can be used to create a digital well plan 100. The following discussion is directed to using the Machine Learning Processor (MLP) to provide an automated method for creating a composite well curve from historical well construction data.

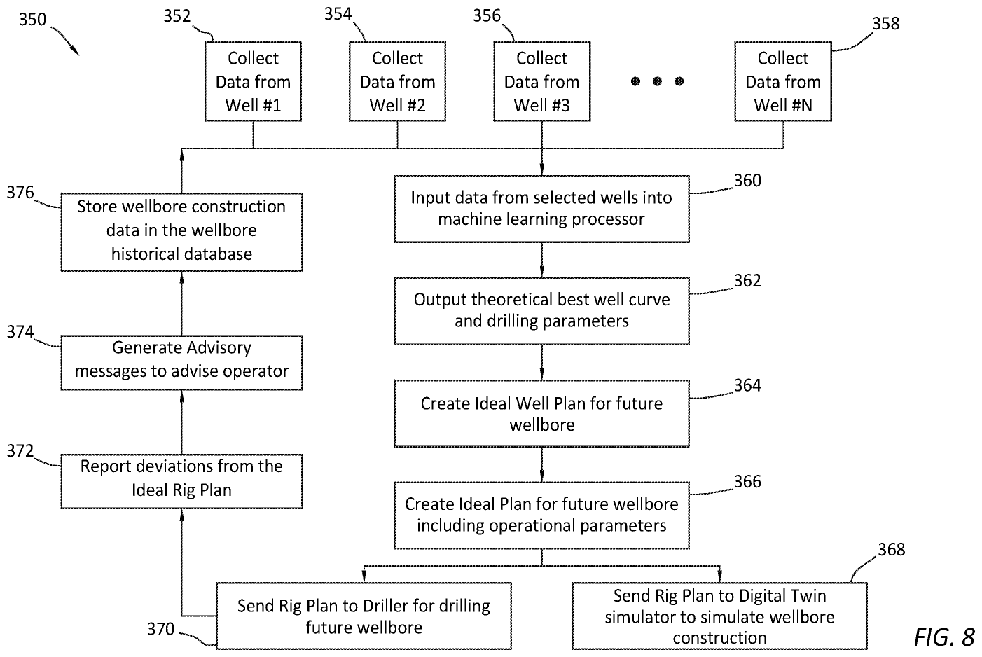

Referring now to FIG. 8, which is a representative high-level flow chart of generating a composite well curve from historical well construction data of previously formed wellbores (e.g., wellbore 15), in accordance with certain embodiments. The MLP can be used to automatically analyze historical well construction datasets for previously formed wellbores to create an optimal composite well curve, which can be used to build a digital well plan 100.

Historical well construction datasets that are tagged with the appropriate IADC operation codes and sub-codes can be input into the MLP to train the MLP to identify operation codes in historical well construction datasets that have not yet been tagged with the IADC codes and sub-codes. The MLP can consume the input data which includes all the operational details of equipment and operational parameters. The datasets used for learning can also include weighted IADC codes and sub-codes depending on the various weighting factors, such as sensitivity of the well construction to the particular operations identified by the codes or sub-codes. Input datasets can be replicated, if needed to improve accuracy of the MLP, and input to the MLP for learning purposes.

The MLP inputs from the datasets can include the tagged IADC codes or sub-codes, Total Depth TotD (ft), true vertical depth TVD (ft), time log (e.g., seconds, minutes, hours, days), tubular string revolutions per minute (RPM), Mud Flow In or out of wellbore (gal/min), rate of penetration ROP (ft/min), Weight on bit WOB (klbs), Pump Pressure (psi), Top Drive Torque (ft-lbs), bottom hole assembly (BHA) parameters (total length, drill bit parameters, mud motor parameters, etc.), mud parameters (e.g., mud weight, pressure gradient, viscosity, solids percentage, etc.), a performance goal, Hook load (klbs), Bit Depth BD (ft), Top Drive RPM, On Bottom (Y/N), Slips Set (Y/N), Operations Summary, Tour Sheet report, Mud Record report, Bit Record report, tubular parameters, drill bit specifications, BHA specifications, mud specifications, tubular specifications, or combinations thereof.

Once the MLP is sufficiently trained, then the MLP can be used to create the well curve for a future well construction. In operation 360, the rig controller 250 can input one or more well construction datasets #1, #2, #3, #N (as in operations 352, 354, 356, 358) from the wellbore historical database 280 (or the recently stored well construction dataset from operation 376) into the MLP. The particular datasets to be included in the MLP processing for creating the new well curve can be selected by a user or autonomously selected by the rig controller 250. The MLP can analyze each dataset to determine the one that performed the best for the specified criteria (such as optimized ROP or the shortest amount of calendar days to complete the wellbore, etc.). The MLP can analyze and compare performance of the various well construction datasets #1, #2, #3, #N (or the recently stored well construction dataset from operation 376) to each other in light of the desired performance criteria. The MLP processing can include analyzing performance of various equipment with various operational parameters.

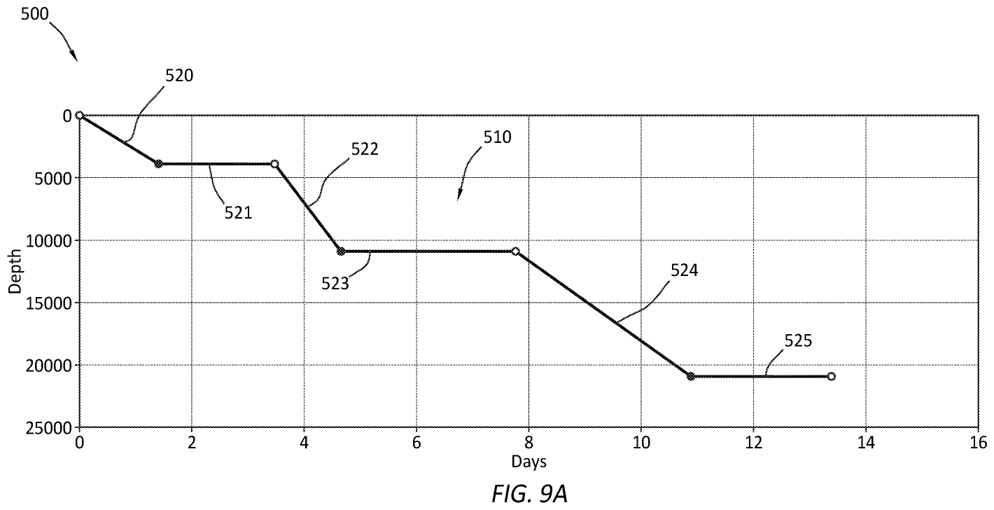

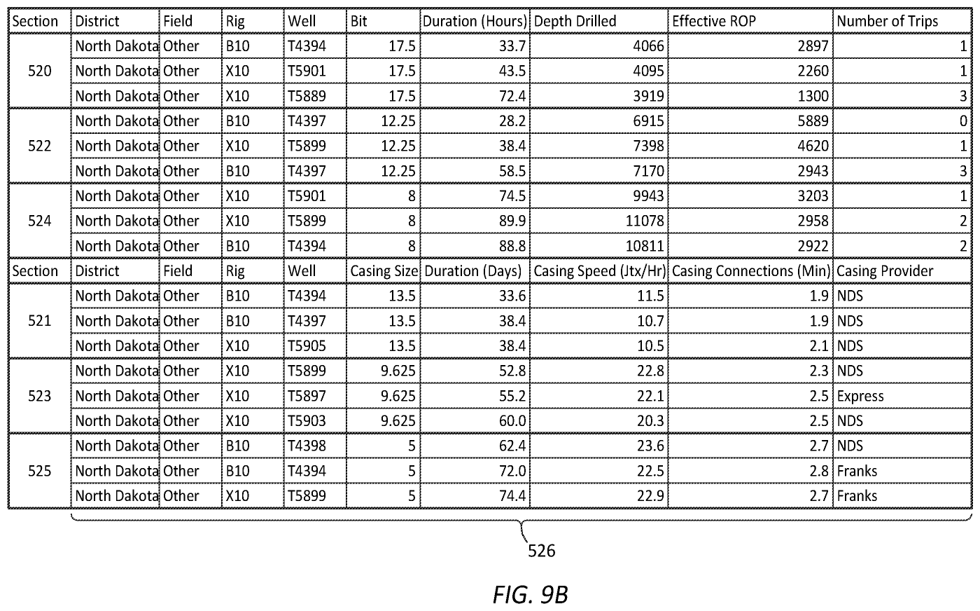

In operation 362, when the MLP consumes the well construction datasets, the MLP can determine a theorical best composite well curve (e.g., well curve 510 in FIG. 9), which can determine durations of drilling zones (e.g., 520, 522, 524) and casing operation zones (e.g., 521, 523, 525) in the well curve. More or fewer drilling and casing operation zones can be included in the well curve 510. In operation 364, this well curve 510 can be used by the rig controller 250 (or well designers) to create an ideal digital well plan 100 for a future wellbore 15 based on the selected wellbore datasets. In operation 366, since the well construction datasets include the operational parameters for performing the rig operations (e.g., recipes for operating rig equipment, mud rheology specifications, BHA design per well sections, bit specifications per well sections, casing tubulars, drilling tubulars, RPMs, ROP, WOB, etc.), then the rig controller 250 can create an ideal digital rig plan 102 including theoretical best operational parameters for forming the future wellbore 15 using a rig 10. This rig 10 is not required to be the rig 10 described above. This rig 10 can be the same or different than the rig 10 of the previous discussions.

In operation 368, the rig controller 250 can send the digital rig plan 102 to a digital twin simulator module which can be included in the rig controller 250 or provided by a separate processor(s). The digital twin simulator can simulate the well construction based on the digital rig plan 102 and be used to measure the actual well construction performance against the well construction performance simulated by the digital twin simulator. The digital twin simulator can output simulation results to a visualization device for viewing by a user 4 or can overlay the digital twin simulation over the actual well construction performance.

In operation 370, the rig controller 250 can send the digital rig plan 102 to a driller (or an auto driller for autonomous drilling) which can use the digital rig plan 102 to construct the future wellbore 15. The digital rig plan 102 can include operational parameters for all rig tasks and rig equipment to form the future wellbore 15. As described above, during execution of the digital rig plan 102, deviations (e.g., planned or unplanned rig tasks, or dysfunctions) from the digital rig plan 102 can occur and the digital rig plan 102 can be modified to handle the deviation. The current method of generating the composite well curve 510 can include capturing and reporting all parameters and rig tasks that were used to handle the deviation. Therefore, this information can be stored in the well construction dataset that is stored in the wellbore historical database once the digital rig plan 102 is fully executed.

Therefore, when the well construction dataset stored in the wellbore historical database 280 is selected to develop another composite well curve 510, the deviations can be included in the input datasets to the MLP and can be used to improve future composite well curves 510. In operation 372, the deviations can be reported so the operators (or users 4) are aware of the deviations and the rig tasks and parameters used to handle the one or more deviations from the ideal digital rig plan 102.

In operation 374, the rig controller 250 can generate advisory messages that can be used to alert a user 4 of HSE recommendations, provide reminders of best practices, alert the user 4 to be aware of a drill bit approaching a different strata in the subterranean formation 8, alert the user 4 of potential hazards based on formation data, of potential alternative rig tasks, of cautionary limits being approached, of the ROP being exceeded, of the ROP not being met, or any other conditions, operations, or safety issues detected. The advisory messages can be stored with the well construction dataset when it is stored in the wellbore historical database 280 in operation 376. For a new composite well curve, the older datasets along with the newly created dataset can be input to the MLP in operation 360 to begin repeating the method 350.

FIG. 9A is a representative plot 500 of a composite well curve 510, in accordance with certain embodiments. This can be an output of operation 362 in FIG. 8. In a non-limiting embodiment, each drilling section 520, 522, 524 of the well curve 510 can be based on ‘N’ historical datasets (only three shown in FIG. 9B). Each dataset can be identified by the display data 526 that can include the rig used to drill the well, the well number, the drill bit used, the duration of the drilling operation, the depth drilled, the effective ROP, and number of trips in the drilling section 520, 522, 524. Each casing section 521, 523, 525 of the well curve 510 can be based on the ‘N’ historical datasets (only three shown in FIG. 9B). Each dataset can be identified by the display data 526 that can include the rig used during the casing operation, the well number of the wellbore in which the casing operation was performed, the casing size used, the duration of the casing operation, casing speed, minimum casing connections, and the casing provider. Other information can be used to identify the drilling and casing operations or displayed to the user for selection purposes.

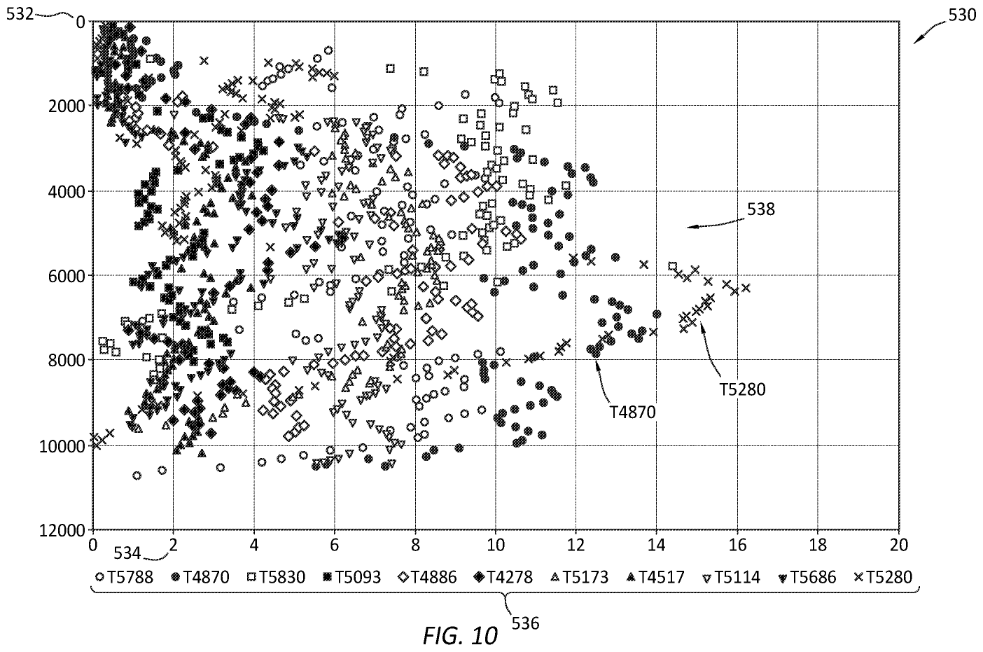

FIG. 10 is a representative plot 530 of performance indices 538 for rig performance of various wellbores 536 (indicated in the legend), in accordance with certain embodiments. The plot 530 provides a visual representation of the performance indices 538 plotted along performance index axis 534 versus wellbore depth 532. This plot 530 can be used by an operator to visually detect outliers that have poor performance, where the smaller the performance index, the better the performance. For example, the wellbores T4870 and T5280 appear to be the worst performers of the group of wellbores 536. With this information, a user can deselect these two wellbores before requesting the MLP to process the wellbore group for creating the composite well curve 510. However, it is not required for a user to make these selections/deselections. The MLP can automatically determine outliers and remove them from the wellbore group to be used to create the composite well curve 510.

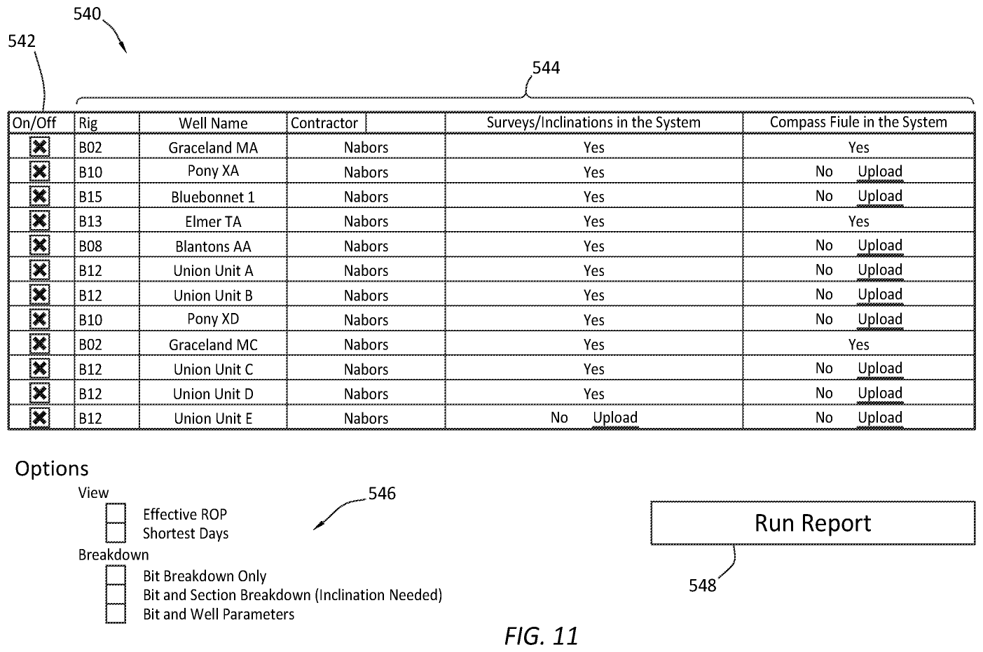

FIG. 11 is a representative graphical user interface (GUI) 540 for selecting data and performance criteria for a machine learning processor (MLP), in accordance with certain embodiments. The GUI 540 can be used by an operator to interact with the MLP and determine which wellbores to be included in the composite well curve 510 generation. The ON/OFF selector buttons 542 can select or deselect each particular wellbore. The display information 544 provides brief identifying information for each wellbore. This display information 544 can be tailored as needed to provide appropriate summary information for each wellbore. The user 4 can select the type of criteria to be used to build the composite well curve 510.

By the user 4 selecting “Effective ROP” via radio buttons 546, the MLP can analyze the data from multiple wellbores and decide the best operational state sequence and the best drilling parameters to provide a composite well curve 510 that is the theoretical best at providing an optimized ROP and maintaining that desired ROP. This criteria would not necessarily produce a wellbore 15 in the shortest amount of time but it can be used to optimize equipment use and minimize wear and strain on equipment and resources.

By the user 4 selecting “Shortest Days” via radio buttons 546, the MLP can analyze the data from multiple wellbores and decide the best operational state sequence and the best drilling parameters to provide a composite well curve 510 that is the theoretical best at providing a wellbore 15 in the shortest amount of time. This criteria would not necessarily produce a wellbore 15 while maintaining an optimized ROP but it can be used when the wellbore 15 is needed as fast as possible accounting for safety.

It should be understood that more performance criteria can be included in the GUI radio buttons 546 to cause the MLP to analyze the data in a different light. For example, “Minimize Emissions” can be an available criteria selection, where it can be used to instruct the MLP to generate the composite well curve 510 so as to optimize use of the power systems (e.g., generators, energy storage systems ESS, secondary power sources, waste energy) to minimize emissions. For example, “Optimize Power Systems” can be an available criteria selection, where it can be used to instruct the MLP to generate the composite well curve 510 so as to optimize use of the power systems, but not necessarily to minimize emissions. Could be for optimizing a specific component of the power systems, such as the ESS, the generator, the secondary power (e.g., wind, solar, geothermal, etc.), the waste energy, etc. For example, “Optimize Personnel” can be an available criteria selection, where it can be used to instruct the MLP to generate the composite well curve 510 so as to optimize use of the rig personnel.

Other selections can be made via the radio buttons 546 that can select a level of details to be included in the composite well curve 510 report from the MLP when the processing is complete. For example, if the “Bit Breakdown Only” is selected, the details of the drilling bits for drilling the composite well curve 510 can be reported to the user 4 or the rig controller 250 for further processing. The sections of the wellbore can be defined by the drill bits used to construct the wellbore 15. For example, if the “Bit and Section Breakdown” is selected, the details of the drilling bits for drilling each section of the composite well curve 510 can be reported to the user 4 or the rig controller 250 for further processing. The sections of the wellbore can be defined by the drill bits used to construct the wellbore 15 as well as inclination information (e.g., vertical, deviated, horizontal, etc.).

For example, if the “Bit and Well Parameters” is selected, the details of the drilling bits for drilling each section of the composite well curve 510 can be reported to the user 4 or the rig controller 250 for further processing. The sections of the wellbore can be defined by the drill bits used to construct the wellbore 15 as well as well parameters (e.g., porosity, resistivity, etc.). When the appropriate wellbores and criteria are selected, the user 4 can then select the “Run Report” button 548 to cause the MLP to generate a composite well curve 510 based on the performance criteria and the selected wellbores.

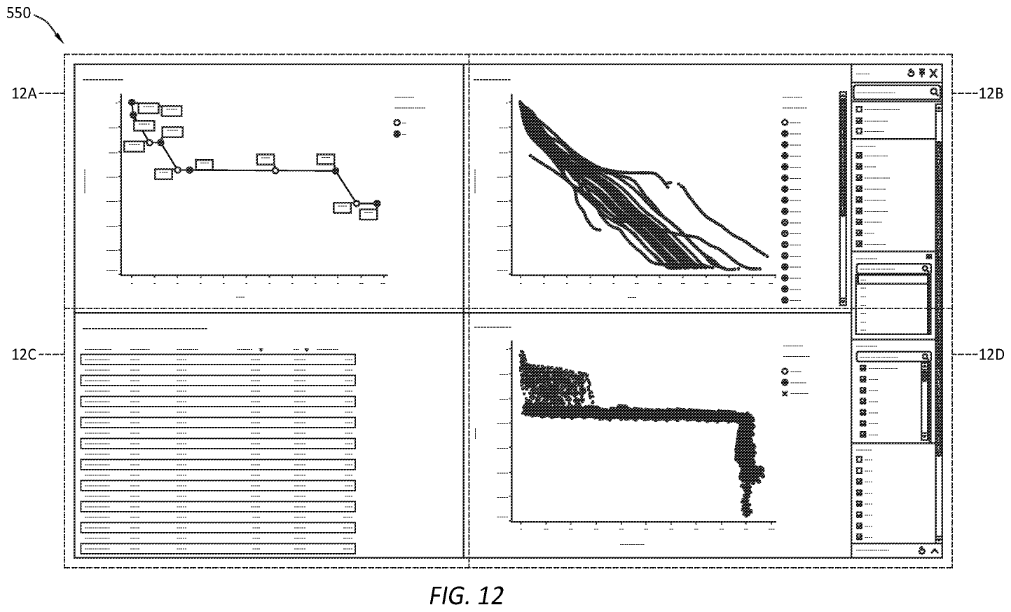

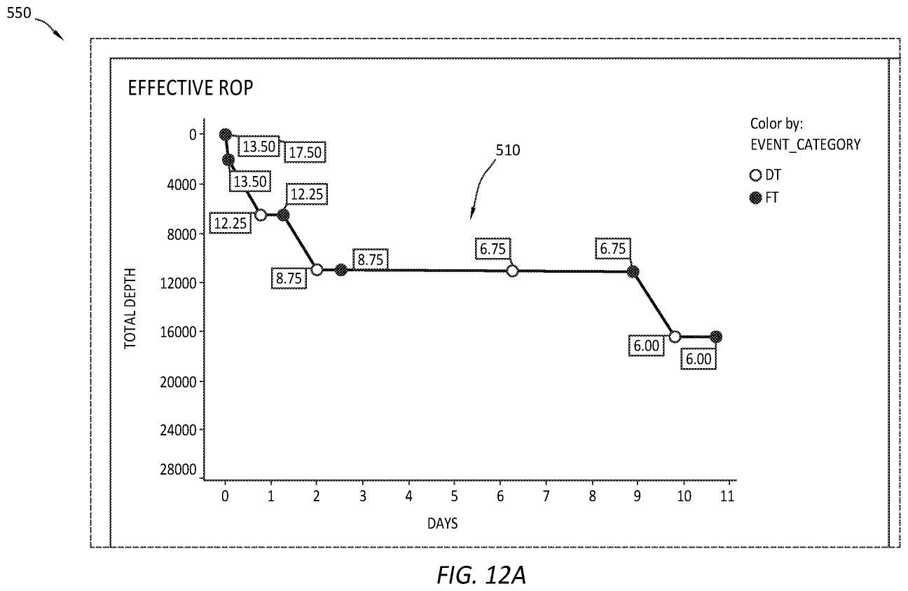

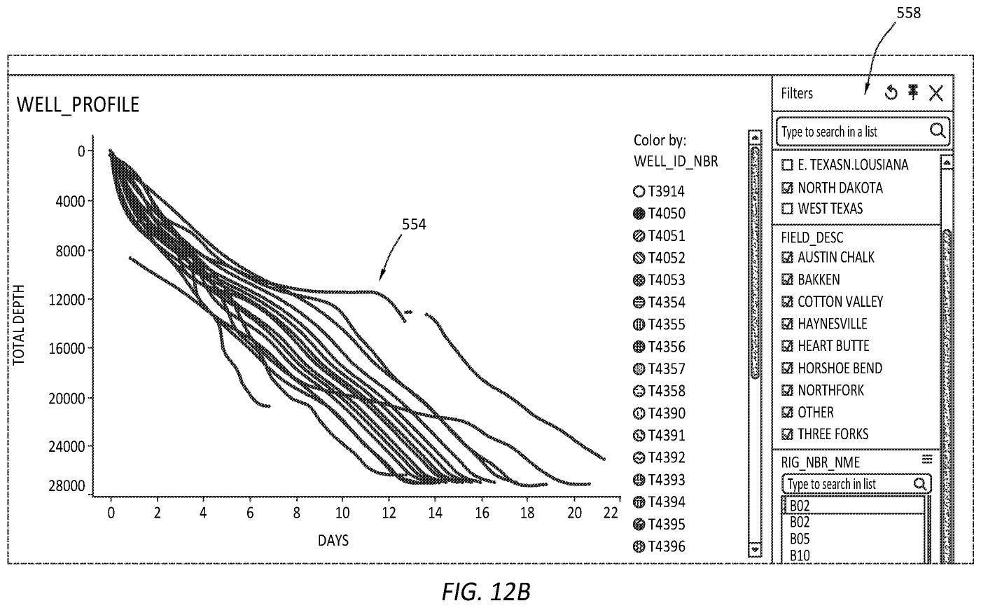

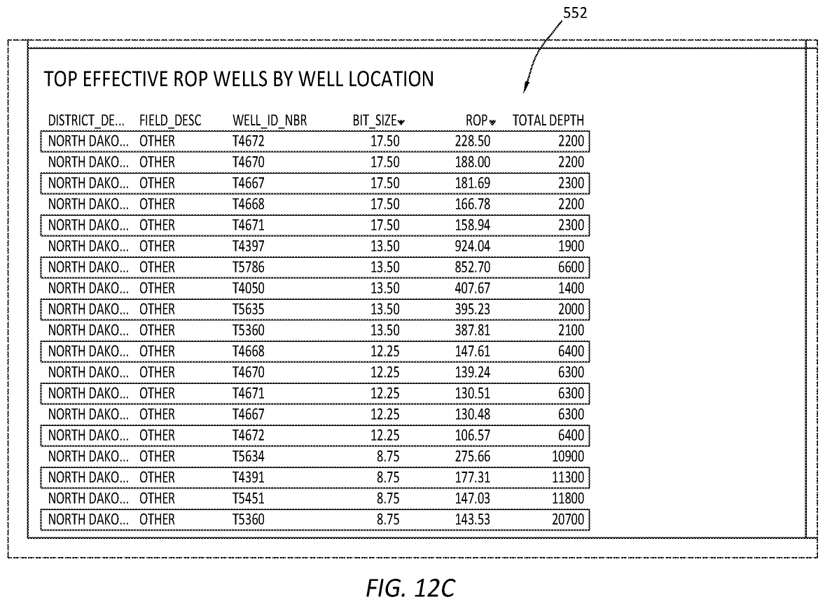

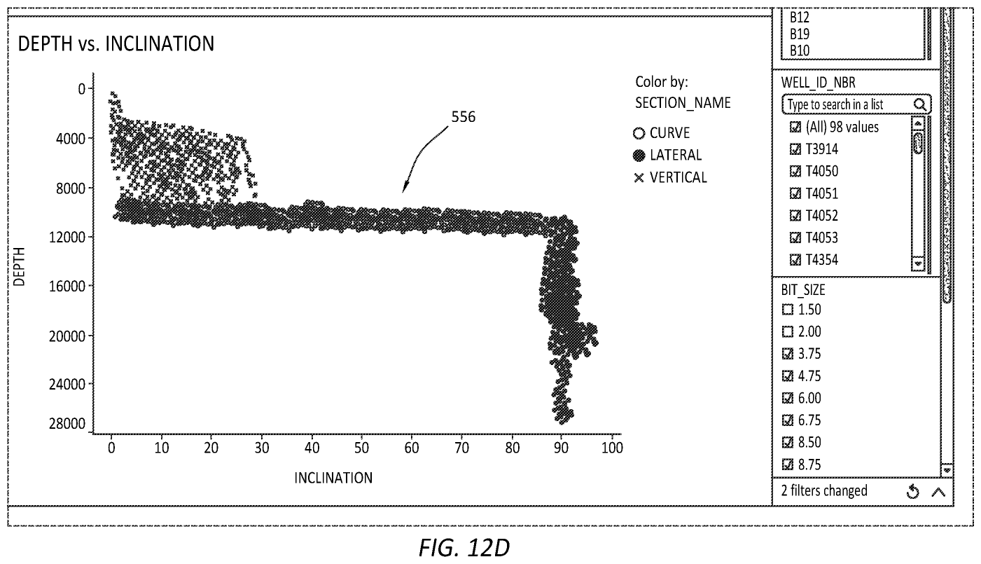

FIG. 12 is a representative GUI for displaying a composite well curve 510 and visual representations of at least some of the wellbore historical data used by the machine learning processor (MLP) to generate the composite well curve 510, in accordance with certain embodiments. FIG. 12 is expanded into four major regions 12A-12D, which are shown in more detail in the respective FIGS. 12A, 12B, 12C, 12D. The table 552 (see FIG. 12C) can be used to display summary information about the wellbores that were selected to generate the composite well curve 510 (see FIG. 12A). The plot 554 (see FIG. 12B) can provide a graphical visualization of the wellbore paths of the wellbores that were selected to generate the composite well curve 510. Additionally, the plot 556 (see FIG. 12D) can be used to display historical data of the selected wellbores as depth per inclination plot. To help the user 4 manage what information is displayed via the GUI 550, the column 558 (see FIGS. 12B and 12D) of filter selections can be used to tailor the information displayed in the table 552, and plots 554, 556.

In general, this disclosure provides an automated method for using wellbore historical data to generate a theoretical best composite well curve 510 based on the desired performance criteria. The composite well curve 510 can be converted, via the rig controller 250, to a digital well plan 100 (examples of which are described above) that is implementation indifferent or tool agnostic. The rig controller 250 can then be used to convert the digital well plan 100 to a digital rig plan 102 (examples of which are described above) when a rig 10 is selected to execute the digital well plan 100, and the digital rig plan 102 can include the theoretical best operational parameters supplied by the MLP and which were determined when the composite well curve 510 was generated.

### VARIOUS EMBODIMENTS

Embodiment 1. A method for generating a composite well curve, the method comprising:
storing, via a controller, performance data for multiple wellbores in a wellbore historical database, wherein the performance data comprises operational parameters for rig equipment as well as operational states of the rig equipment;
selecting, via the controller, one or more wellbores from the wellbore historical database;
retrieving, via a machine learning processor (MLP), performance data for the one or more wellbores;
analyzing, via the MLP, performance indices of the one or more wellbores relative to wellbore depth;
determining, via the MLP, which of the one or more wellbores performed best based on the performance indices at each depth for a selected performance criteria; and
selecting the best performance at each depth from the one or more wellbores; and
generating a composite well curve based on the best performance at each depth.

Embodiment 2. The method of embodiment 1, wherein each depth is a depth interval.

Embodiment 3. A method for generating a composite well curve, the method comprising:
inputting performance data from multiple wellbores into a machine learning processor (MLP);
processing, via the MLP, the performance data based on a selected performance criteria; and
generating, via the MLP, an optimized composite well curve along with an optimized set of operational parameters for drilling a future wellbore based on selecting high performing sections from the multiple wellbores and assembling the high performing sections together into the optimized composite well curve.

Embodiment 4. The method of embodiment 3, further comprising:
generating, via a controller, a digital well plan based on the optimized composite well curve; and
generating, via the controller, a digital rig plan based on the digital well plan and the optimized composite well curve, which contains the optimized set of operational parameters.

Embodiment 5. The method of embodiment 4, further comprising:
drilling a wellbore based on the digital rig plan;
recording deviations from the digital rig plan;
reporting the deviations from the digital rig plan; and
storing rig tasks and operation parameters with well construction data for the wellbore when the wellbore is completed.

Embodiment 6. The method of embodiment 5, further comprising:
generating a second composite well curve based at least in part on the deviations.

Embodiment 7. The method of embodiment 3, wherein the optimized composite well curve can include advisory messages used to inform a user of pertinent information about an occurring or soon to occur issue.

Embodiment 8. The method of embodiment 3, wherein the optimized composite well curve is generated to construct a wellbore while maintaining an effective ROP.

Embodiment 9. The method of embodiment 3, wherein the optimized composite well curve is generated to construct a wellbore in a shortest period of time.

Embodiment 10. A method for generating a composite well curve, the method comprising:
selecting, via a controller, one or more wellbores from a wellbore historical database;
retrieving, via a machine learning processor (MLP), performance data for the one or more wellbores;
determining, via the MLP, performance indices of the one or more wellbores relative to wellbore depth based on the performance data;
determining, via the MLP, which of the one or more wellbores performed best at each depth based on the performance indices at each depth for a selected performance criteria;
selecting the best performance at each depth from the one or more wellbores; and
generating a composite well curve based on the best performance at each depth.

Embodiment 11. The method of embodiment 10, wherein the depth is a depth interval.

Embodiment 12. The method of embodiment 10, further comprising, prior to selecting the one or more wellbores, storing, via the controller, performance data for multiple wellbores in the wellbore historical database, wherein the performance data comprises operational parameters for rig equipment as well as operational states of the rig equipment.

Embodiment 13. The method of embodiment 12, further comprising:
capturing well construction data for each of the one or more wellbores after each of the one or more wellbores is completed, wherein the well construction data comprises:
how, when, or where specific equipment, personnel, or parameters are used to execute each task of a digital rig plan which was used to construct the respective one of the one or more wellbores;
material specifications for equipment used in each task of the respective digital rig plan;
performance goals for each task of the respective digital rig plan;
performance indices for each task of the respective digital rig plan;
BHA details for each task of the respective digital rig plan;
formation measurement data;
survey data; or
combinations thereof.

Embodiment 14. The method of embodiment 13, further comprising, prior to storing the performance data for multiple wellbores in the wellbore historical database, tagging the well construction data with operational state codes for each of the one or more wellbores to indicate an operational state of a rig when each task of the digital rig plan was executed.

Embodiment 15. The method of embodiment 14, wherein the operational state codes comprise International Association of Drilling Contractors (IADC) codes.

Embodiment 16. The method of embodiment 14, wherein MLP determines the performance indices of the one or more wellbores relative to wellbore depth based the operational state codes.

Embodiment 17. The method of embodiment 10, wherein the selected performance criteria comprises:
an optimized rate of penetration (ROP);
a shortest amount of calendar days to complete a wellbore;
minimized emissions;
optimized power systems;
optimized personnel; or
combinations thereof.

Embodiment 18. The method of embodiment 10, further comprising developing, via the controller, a digital well plan for a future wellbore based on the composite well curve.

Embodiment 19. The method of embodiment 18, further comprising developing, via the controller, a digital rig plan for a future wellbore based on the digital well plan and a rig.

Embodiment 20. The method of embodiment 19, further comprising drilling the future wellbore based on the digital rig plan.

Embodiment 21. The method of embodiment 20, further comprising:
recording deviations from the digital rig plan;
reporting the deviations from the digital rig plan; and
storing rig tasks and operation parameters with well construction data for the future wellbore in the wellbore historical database when the future wellbore is completed.

Embodiment 22. A method for generating a composite well curve, the method comprising:
inputting performance data from multiple wellbores into a machine learning processor (MLP);
processing, via the MLP, the performance data based on a selected performance criteria; and
generating, via the MLP, an optimized composite well curve along with an optimized set of operational parameters for drilling a future wellbore based on selecting high performing sections from the multiple wellbores and assembling high performing sections together into the optimized composite well curve.

Embodiment 23. The method of embodiment 22, further comprising generating, via a controller, a digital well plan based on the optimized composite well curve.

Embodiment 24. The method of embodiment 23, further comprising generating, via the controller, a digital rig plan based on the digital well plan and the optimized composite well curve, which contains the optimized set of operational parameters.

Embodiment 25. The method of embodiment 24, further comprising:
drilling a wellbore based on the digital rig plan;
recording deviations from the digital rig plan;
reporting the deviations from the digital rig plan; and
storing rig tasks and operation parameters with well construction data for the wellbore when the wellbore is completed.

Embodiment 26. The method of embodiment 25, further comprising generating a second composite well curve based at least in part on the deviations.

Embodiment 27. The method of embodiment 22, wherein the optimized composite well curve can include advisory messages used to inform a user of pertinent information about an occurring or soon to occur issue.

Embodiment 28. The method of embodiment 22, wherein the optimized composite well curve is generated to construct a wellbore while maintaining an effective ROP.

Embodiment 29. The method of embodiment 22, wherein the optimized composite well curve is generated to construct a wellbore in a shortest period of time.

While the present disclosure can be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

What is claimed is:

1. A method for generating a composite well curve, the method comprising:
selecting, via a controller, one or more wellbores from a wellbore historical database;
retrieving, via a machine learning processor (MLP), performance data for the one or more wellbores;
determining, via the MLP, performance indices of the one or more wellbores relative to wellbore depth based on the performance data;
determining, via the MLP, which of the one or more wellbores performed best at each depth based on the performance indices at each depth for a selected performance criteria;
selecting the best performance at each depth from the one or more wellbores; and
generating a composite well curve based on the best performance at each depth.

2. The method of claim 1, wherein the depth is a depth interval.

3. The method of claim 1, further comprising:
prior to selecting the one or more wellbores, storing, via the controller, performance data for multiple wellbores in the wellbore historical database, wherein the performance data comprises operational parameters for rig equipment as well as operational states of the rig equipment.

4. The method of claim 3, further comprising:
capturing well construction data for each of the one or more wellbores after each of the one or more wellbores is completed, wherein the well construction data comprises:
how, when, or where specific equipment, personnel, or parameters are used to execute each task of a digital rig plan which was used to construct the respective one of the one or more wellbores;
material specifications for equipment used in each task of the respective digital rig plan;
performance goals for each task of the respective digital rig plan;
performance indices for each task of the respective digital rig plan;
BHA details for each task of the respective digital rig plan;
formation measurement data;
survey data; or
combinations thereof.

5. The method of claim 4, further comprising prior to storing the performance data for multiple wellbores in the wellbore historical database, tagging the well construction data with operational state codes for each of the one or more wellbores to indicate an operational state of a rig when each task of the digital rig plan was executed.

6. The method of claim 5, wherein the operational state codes comprise International Association of Drilling Contractors (IADC) codes.

7. The method of claim 5, wherein MLP determines the performance indices of the one or more wellbores relative to wellbore depth based the operational state codes.

8. The method of claim 1, wherein the selected performance criteria comprises:
an optimized rate of penetration (ROP);
a shortest amount of calendar days to complete a wellbore;
minimized emissions;
optimized power systems;
optimized personnel; or
combinations thereof.

9. The method of claim 1, further comprising developing, via the controller, a digital well plan for a future wellbore based on the composite well curve.

10. The method of claim 9, further comprising developing, via the controller, a digital rig plan for a future wellbore based on the digital well plan and a rig.

11. The method of claim 10, further comprising drilling the future wellbore based on the digital rig plan.

12. The method of claim 11, further comprising:
recording deviations from the digital rig plan;
reporting the deviations from the digital rig plan; and
storing rig tasks and operation parameters with well construction data for the future wellbore in the wellbore historical database when the future wellbore is completed.

13. A method for generating a composite well curve, the method comprising:
inputting performance data from multiple wellbores into a machine learning processor (MLP); and
processing, via the MLP, the performance data based on a selected performance criteria;
generating, via the MLP, an optimized composite well curve along with an optimized set of operational parameters for drilling a future wellbore based on selecting high performing sections from the multiple wellbores and assembling high performing sections together into the optimized composite well curve.

14. The method of claim 13, further comprising generating, via a controller, a digital well plan based on the optimized composite well curve.

15. The method of claim 14, further comprising generating, via the controller, a digital rig plan based on the digital well plan and the optimized composite well curve, which contains the optimized set of operational parameters.

16. The method of claim 15, further comprising:
drilling a wellbore based on the digital rig plan;
recording deviations from the digital rig plan;
reporting the deviations from the digital rig plan; and
storing rig tasks and operation parameters with well construction data for the wellbore when the wellbore is completed.

17. The method of claim 16, further comprising generating a second composite well curve based at least in part on the deviations.

18. The method of claim 13, wherein the optimized composite well curve can include advisory messages used to inform a user of pertinent information about an occurring or soon to occur issue.

19. The method of claim 13, wherein the optimized composite well curve is generated to construct a wellbore while maintaining an effective ROP.

20. The method of claim 13, wherein the optimized composite well curve is generated to construct a wellbore in a shortest period of time.
